(19) United States
(12) Patent Application Publication
(10) Pub. No.: US 2019/0247839 A1
(43) Pub. Date: Aug. 15, 2019

(54) MODIFIED POROUS ORGANIC FRAMEWORK AND MANUFACTURING METHOD THEREOF, POROUS ORGANIC FRAMEWORK COMPOSITE AND MANUFACTURING METHOD THEREOF

(71) Applicant: CHUNG YUAN CHRISTIAN UNIVERSITY, TAOYUAN CITY (TW)

(72) Inventors: Chia-Her LIN, Hsinchu City (TW); Sheng-Han LO, Chiayi County (TW); Kuang-Lieh LU, Taipei (TW)

(21) Appl. No.: 16/212,639

(22) Filed: Dec. 6, 2018

(30) Foreign Application Priority Data
Feb. 14, 2018 (TW) 107105647

(51) Int. Cl. B01J 31/16; B01J 37/04

(52) U.S. Cl. CPC B01J 31/1691; B01J 31/1658; B01J 2531/004; B01J 2231/005; B01J 37/04

(57) ABSTRACT

A method for manufacturing a modified porous organic framework includes steps as follows. A mixed solution is provided. The mixed solution includes a porous organic framework, a plurality of group donors and a solvent. The porous organic framework includes a plurality of first ligands. Each of the first ligands includes at least one tetrazine group. Each of the group donors includes a reactive group and a modifying group covalently connected with each other. The reactive groups are alkenyl groups, alkynyl groups, aldehyde groups, ketone groups or a combination thereof. A modifying step is conducted, wherein at least one of the reactive groups of the group donors is reacted with at least one of the tetrazine groups of the first ligands, so that at least one of the modifying groups of the group donors is covalently connected with the porous organic framework, whereby the modified porous organic framework is obtained.

### RELATED APPLICATIONS

This application claims priority to Taiwan Application Serial Number 107105647, filed Feb. 14, 2018, which is herein incorporated by reference.

### BACKGROUND

### Technical Field

The present disclosure relates to a modified porous organic framework (POF), a porous organic framework composite and manufacturing methods thereof. More particularly, the present disclosure relates to a modified porous organic framework and a porous organic framework composite using a porous organic framework containing a tetrazine group as reactant and manufacturing methods thereof.

### Description of Related Art

Porous organic frameworks are widely used in the field of chemistry, biology, medicine and environment, and thus become the development focus of contemporary material science. Porous organic frameworks include metal organic framework (MOF) and covalent organic framework (COF). The metal organic framework is a one-dimensional structure, a two-dimensional structure or a three-dimensional structure constructed by organic ligands and metal clusters. The covalent organic framework has no metal, but is a one-dimensional structure, a two-dimensional structure or a three-dimensional structure constructed by atoms, such as boron, carbon, nitrogen, oxygen and silicon, through covalent bonds. Due to the pores of the porous organic frameworks, the porous organic frameworks have potential for the application of gas storage (such as the storage of hydrogen, methane or carbon dioxide), gas purification, gas separation, catalyst, sensor and capacitor.

For further broadening the application scope of the porous organic frameworks, different functional groups can be modified to the porous organic frameworks via post-synthetic modification, so that different properties can be featured to the porous organic frameworks. However, most of the conventional methods for modifying the porous organic framework have the drawback of complicated steps. Furthermore, the kinds of functional groups which can be modified to the porous organic frameworks are still limited.

Therefore, the relevant industries and academics still seek for a method for manufacturing the modified porous organic framework, which has advantages of simple steps and is favorable for modifying different kinds of functional groups to the porous organic framework so as to broaden the application scope of the porous organic framework.

### SUMMARY

According to one aspect of the present disclosure, a method for manufacturing a modified porous organic framework includes steps as follows. A mixed solution is provided, wherein the mixed solution includes a porous organic framework, a plurality of group donors and a solvent. The porous organic framework includes a plurality of first ligands, and each of the first ligands includes at least one tetrazine group. Each of the group donors includes a reactive group and a modifying group covalently connected with each other. The reactive groups of the group donors are alkenyl groups, alkynyl groups, aldehyde groups, ketone groups or a combination thereof. A modifying step is conducted, wherein at least one of the reactive groups of the group donors is reacted with at least one of the tetrazine groups of the first ligands, so that at least one of the modifying groups of the group donors is covalently connected with the porous organic framework, whereby the modified porous organic framework is obtained.

According to another aspect of the present disclosure, a modified porous organic framework is provided. The modified porous organic framework is manufactured by the aforementioned method for manufacturing the modified porous organic framework.

According to further another aspect of the present disclosure, a method for manufacturing a porous organic framework composite includes steps as follows. A first material is provided, wherein the first material includes a plurality of reactive groups, and the reactive groups are alkenyl groups, alkynyl groups, aldehyde groups, ketone groups or a combination thereof. A porous organic framework source is provided, wherein the porous organic framework source includes a porous organic framework or a precursor of the porous organic framework. The porous organic framework and the precursor of the porous organic framework include a plurality of first ligands, and each of the first ligands includes at least one tetrazine group. A combining step is conducted, wherein at least one of the reactive groups of the first material is reacted with at least one of the tetrazine groups of the first ligands, so that the porous organic framework and the first material are covalently connected, whereby the porous organic framework composite is obtained.

According to yet another aspect of the present disclosure, a porous organic framework composite is provided. The porous organic framework composite is manufactured by the aforementioned method for manufacturing the porous organic framework composite.

### BRIEF DESCRIPTION OF THE DRAWINGS

The patent or application file contains at least one drawing executed in color. Copies of this patent or patent application publication with color drawing(s) will be provided by Office upon request and payment of the necessary fee. The present disclosure can be more fully understood by reading the following detailed description of the embodiment, with reference made to the accompanying drawings as follows:

FIG. 1 is a flow diagram showing a method for manufacturing a modified porous organic framework according to one embodiment of the present disclosure.

FIG. 2 is a flow diagram showing a method for manufacturing a modified porous organic framework according to another embodiment of the present disclosure.

FIG. 3 is a schematic view showing a structure of a modified porous organic framework according to further another embodiment of the present disclosure.

FIG. 4 is a flow diagram showing a method for manufacturing a porous organic framework composite according to yet another embodiment of the present disclosure.

FIG. 5 is a schematic view showing a structure of a porous organic framework composite according to yet another embodiment of the present disclosure.

FIG. 6A is a diagram showing Powder X-Ray diffractometer (PXRD) results of a porous organic framework AlTz68 and a modified porous organic framework AlTz68-C18.

FIG. 6B is a schematic view showing a structure of a starting material and a product of Example 2.

FIG. 6C shows nitrogen adsorption isotherms of the porous organic framework AlTz68 and Example 2.

FIG. 6D shows pore size distributions of the porous organic framework AlTz68 and Example 2.

FIG. 6E shows a measurement result of a contact angle of Example 2.

FIG. 7A is a diagram showing PXRD results of the porous organic framework AlTz68 and a modified porous organic framework AlTz68-C18′.

FIG. 7B is a schematic view showing a structure of a starting material and a product of Example 3.

FIG. 7C shows nitrogen adsorption isotherms of the porous organic framework AlTz68 and Example 3.

FIG. 7D shows pore size distributions of the porous organic framework AlTz68 and Example 3.

FIG. 7E shows a measurement result of a contact angle of Example 3.

FIG. 8A is a diagram showing PXRD results of a porous organic framework ZrTz68 and a modified porous organic framework ZrTz68-C18.

FIG. 8B is another diagram showing PXRD results of the porous organic framework ZrTz68 and the modified porous organic framework ZrTz68-C18.

FIG. 8C shows measurement results of contact angles of Example 4, Example 5 and Example 6.

FIG. 9 is a diagram showing a PXRD result of the Example 7.

FIG. 10 is a diagram showing a PXRD result of the Example 8.

FIG. 11 is a diagram showing a PXRD result of the Example 9.

FIG. 12 is a diagram showing PXRD results of the porous organic framework AlTz68 and a modified porous organic framework AlTz68-protoporphyrin IX-ZnCl₂.

FIG. 13A is a diagram showing PXRD results of the porous organic framework AlTz68 and a modified porous organic framework lipase@AlTz68.

FIG. 13B shows absorption spectra of the porous organic framework AlTz68, a control example and Example 11.

FIG. 13C shows relative activities of the porous organic framework AlTz68, the control example and Example 11.

FIG. 14A is a diagram showing PXRD results of a porous organic framework AlTz53 and a porous organic framework composite AlTz53-glass.

FIG. 14B is a scanning electron microscope (SEM) image of Example 12.

FIG. 15A is a diagram showing PXRD results of the porous organic framework AlTz53, a silicon wafer substrate and a porous organic framework composite AlTz53-Si wafer.

FIG. 15B is a SEM image of Example 13.

FIG. 16 is a diagram showing PXRD results of the porous organic framework AlTz68 and a porous organic framework composite AlTz68-C₆₀.

FIG. 17 is a diagram showing PXRD results of the porous organic framework AlTz68 and a porous organic framework composite AlTz68-MWCNT.

FIG. 18 is a diagram showing PXRD results of the porous organic framework AlTz68 and a porous organic framework composite AlTz68-graphene.

FIG. 19 shows results of a first solution, a second solution and a solution of a porous organic framework composite CQD irradiated with ultraviolet light.

### DETAILED DESCRIPTION

According to the present disclosure, a group can be a substituted group or an unsubstituted group unless otherwise specified. For example, an “alkyl group” can be a substituted alkyl group or an unsubstituted alkyl group. Moreover, when “Cx” is used to describe a group, it refers that the group has a main chain with X carbon atoms.

According to the present disclosure, the following phrases have identical meanings: “the first ligand can have a structure represented by Formula (I-1)”, “the first ligand of Formula (I-1)”, and “the first ligand (I-1)”. The representations can be applied to other compounds, so that an explanation thereof in this regard will not be provided again.

According to the present disclosure, “the first” and “the second” are used for nomenclature but not for the arrangement order or the use order. For example, “the first ligand” and “the second ligand” are the names of two ligands.

According to the present disclosure, a structure of a compound can be represented by skeleton formula, which means carbon atoms, hydrogen atoms and carbon-hydrogen bonds of the compound can be omitted. However, if functional groups are specifically depicted in the structure of the compound, the structure of the compound adopts the one with specifically depicted functional groups.

<Method for Manufacturing Modified Porous Organic Framework>

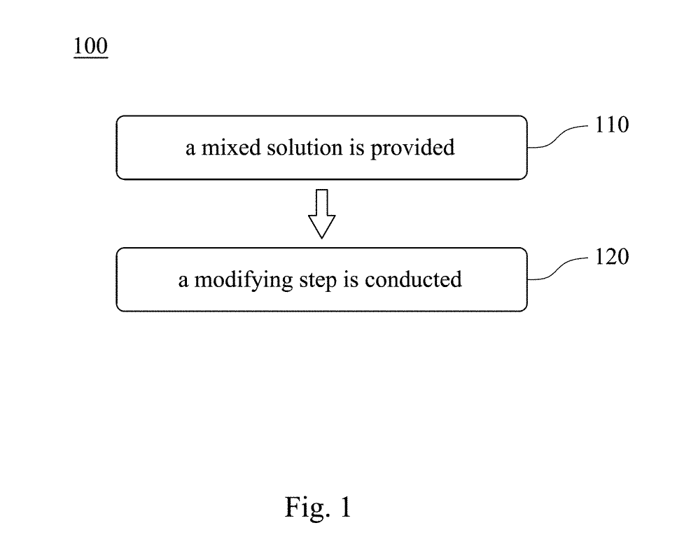

FIG. 1 is a flow diagram showing a method for manufacturing a modified porous organic framework 100 according to one embodiment of the present disclosure. In FIG. 1, the method for manufacturing the modified porous organic framework 100 includes Step 110 and Step 120.

In Step 110, a mixed solution is provided. The mixed solution includes a porous organic framework, a plurality of group donors and a solvent. The porous organic framework includes a plurality of first ligands. Each of the first ligands includes at least one tetrazine group. Each of the group donors includes a reactive group and a modifying group, wherein the reactive group and the modifying group of each of the group donors are covalently connected with each other. The reactive groups of the group donors are alkenyl groups, alkynyl groups, aldehyde groups, ketone groups or a combination thereof.

In Step 120, a modifying step is conducted. At least one of the reactive groups of the group donors is reacted with at least one of the tetrazine groups of the first ligands, so that at least one of the modifying groups of the group donors is covalently connected with the porous organic framework, whereby the modified porous organic framework is obtained.

With the porous organic framework including the tetrazine groups, and the reactive groups of the group donors being alkenyl groups, alkynyl groups, aldehyde groups, ketone groups or a combination thereof, the porous organic framework can be modified with the modifying groups through a click reaction so as to feature the porous organic framework with different properties, which is simple and can broaden the application scope of the porous organic framework. In other words, the kinds of the modifying groups can be selected according to practical demands, so that the modified porous organic framework with different functional groups (i.e., the modifying groups) can be manufactured for satisfying different application goals.

The porous organic framework can be a metal organic framework (MOF) or a covalent organic framework (COF).

When the porous organic framework is the metal organic framework, the porous organic framework includes the first ligands and a plurality of metal clusters. Each of the first ligands can have, but is not limited to, a structure represented by Formula (I-1), Formula (I-2), Formula (I-3), Formula (I-4) or Formula (I-5):

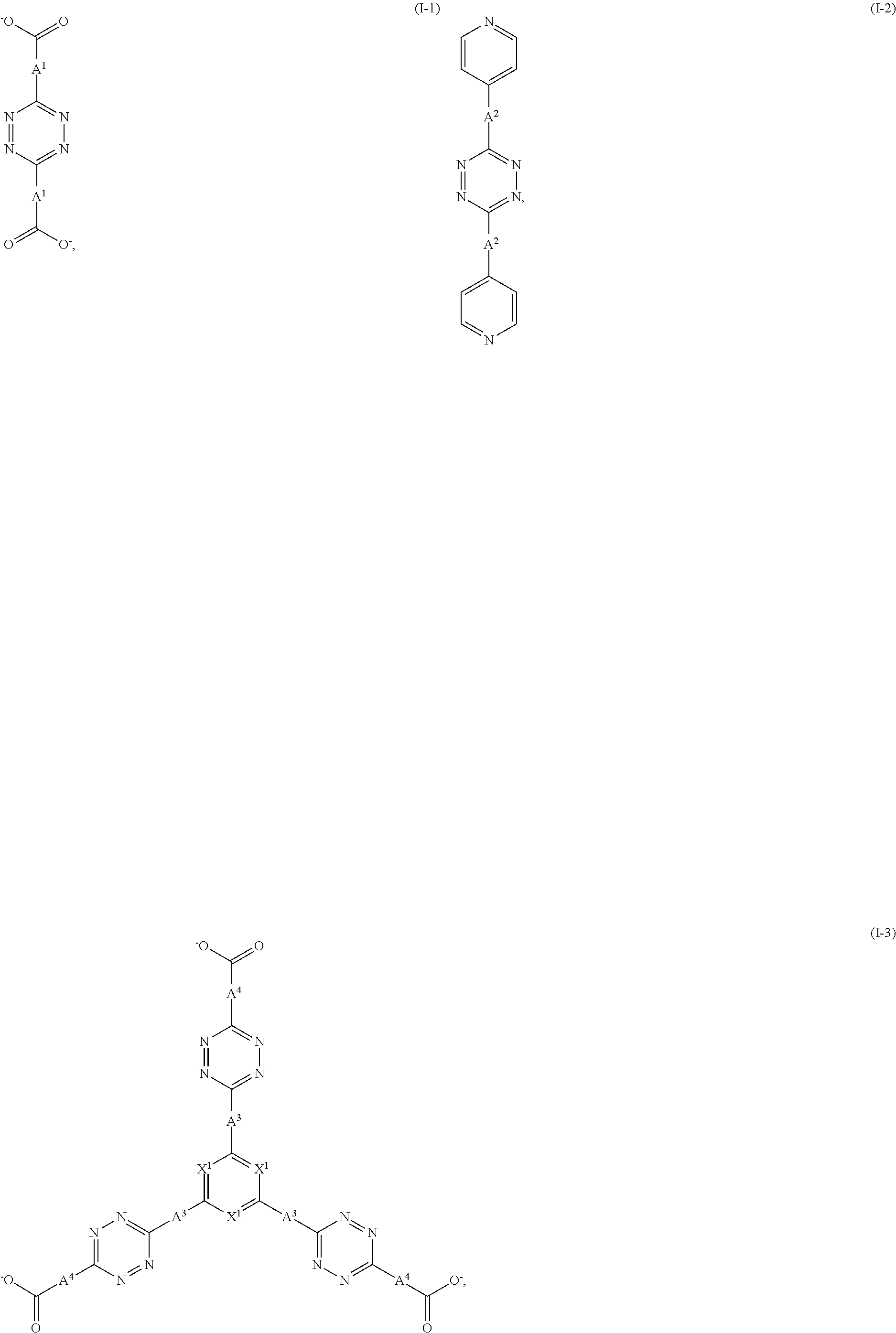

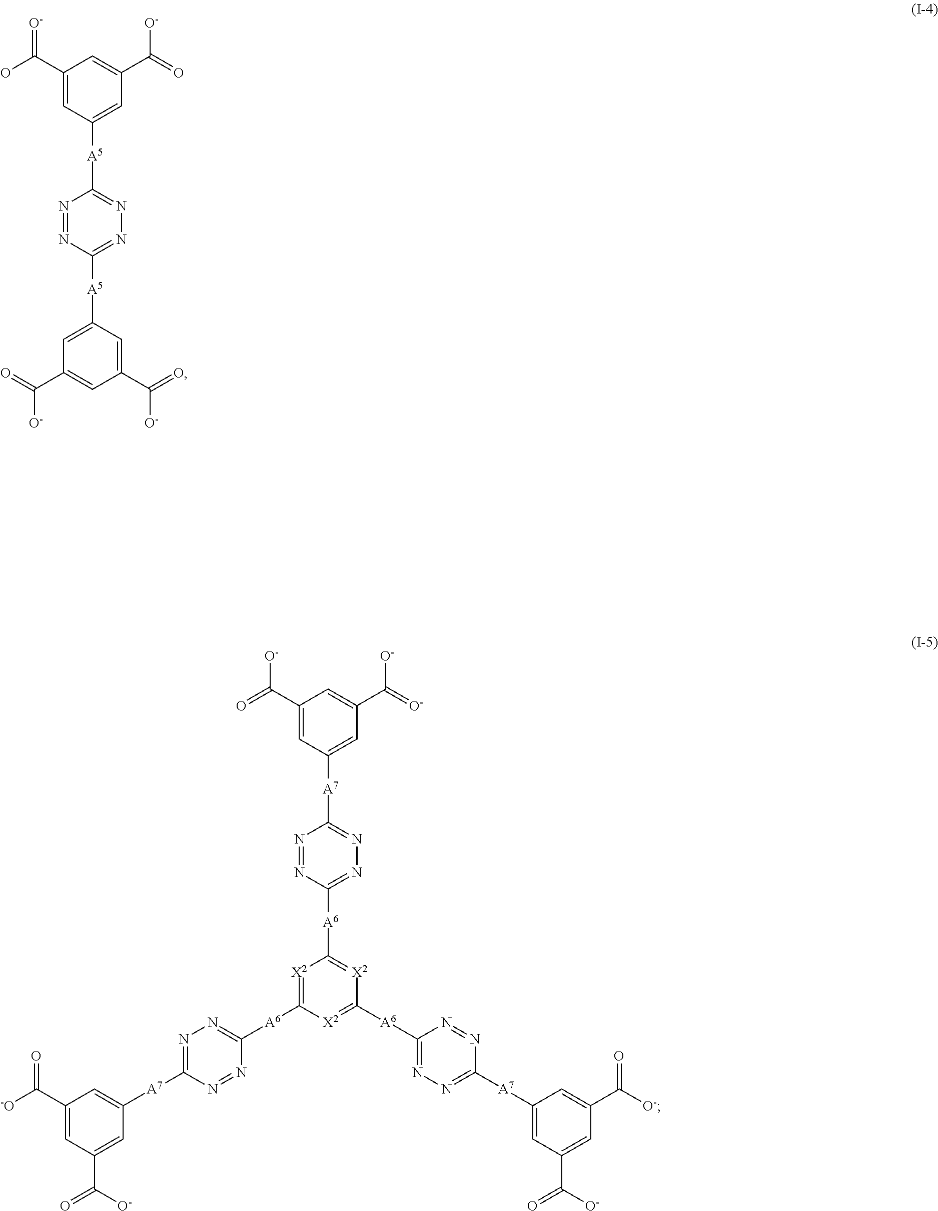

wherein each of A¹, A², A³, A⁴, A⁵, A⁶ and A⁷ independently represents a single bond or a divalent organic group, and each of X¹ and X² independently represents N or C.

The first ligand (I-1) can have, but is not limited to, a structure represented by one of Formula (I-1-1) to Formula (I-1-13):

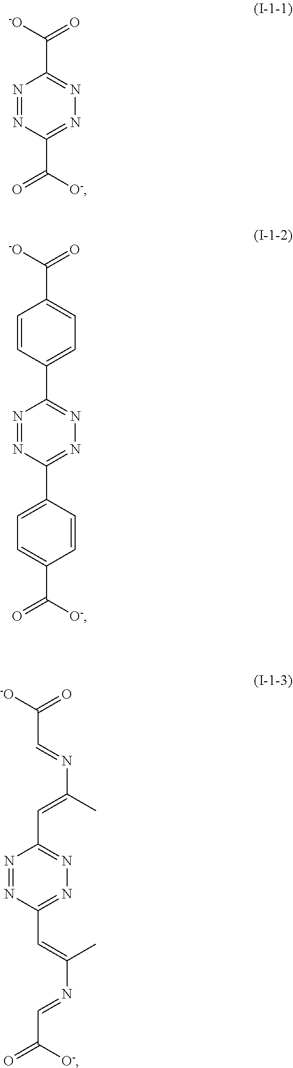

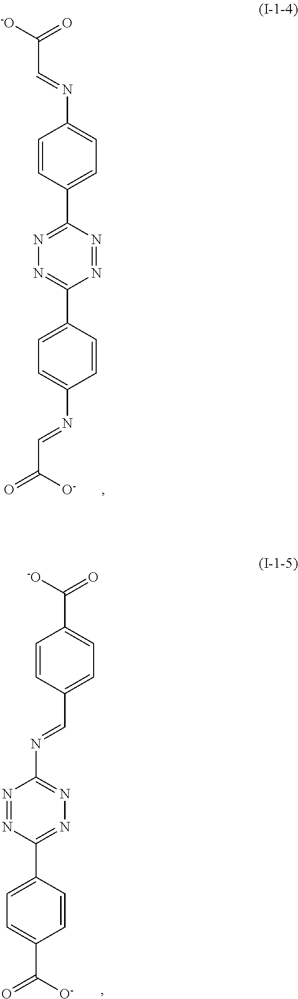

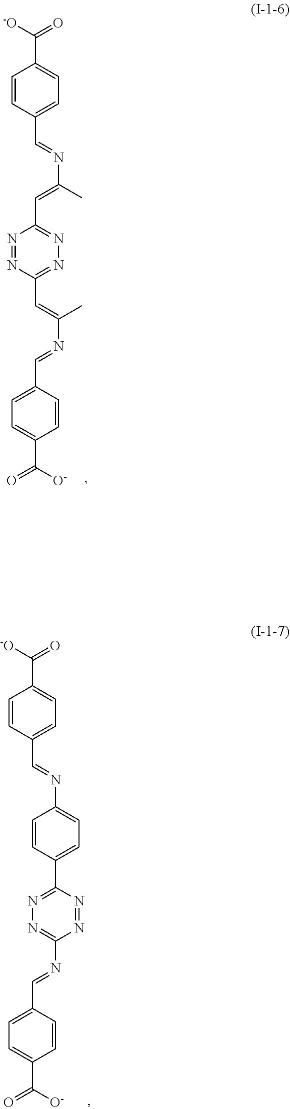

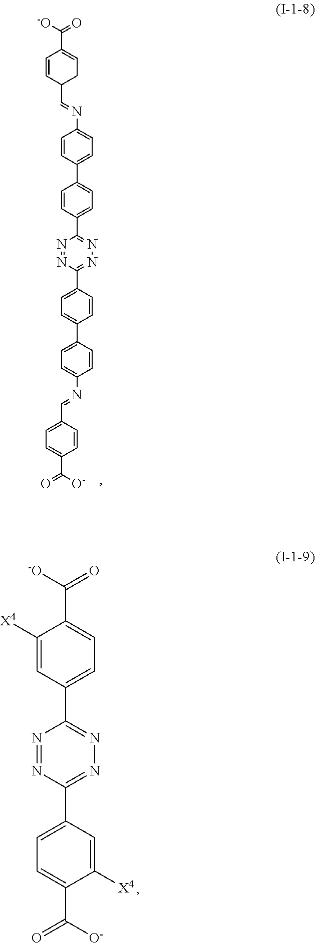

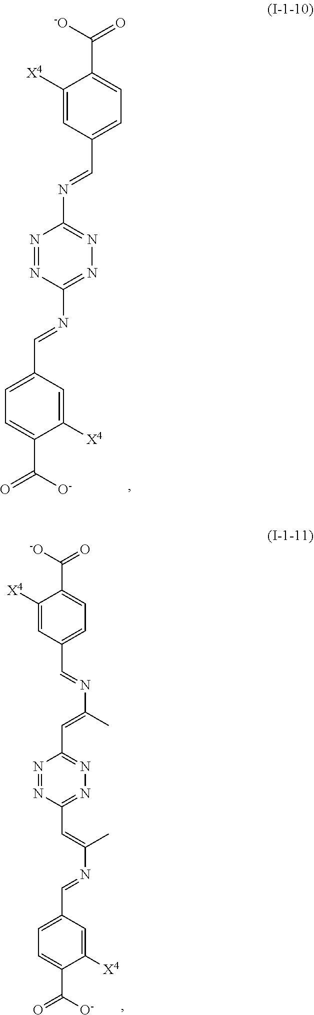

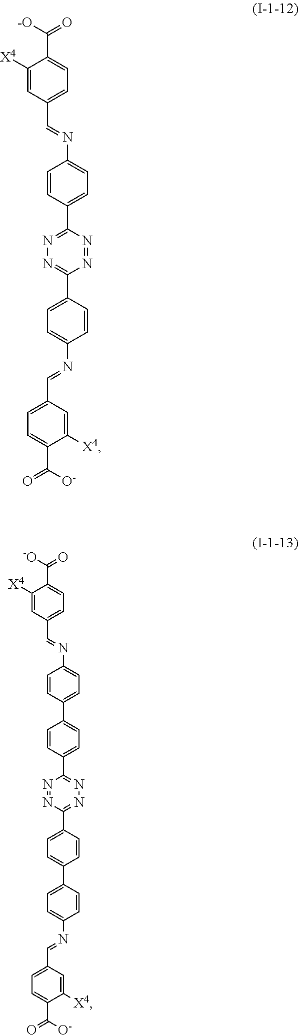

wherein each of X⁴ independently represents a hydroxyl group (—OH) or a thiol group (—SH).

The first ligand (I-2) can have, but is not limited to, a structure represented by one of Formula (I-2-1) to Formula (I-2-5):

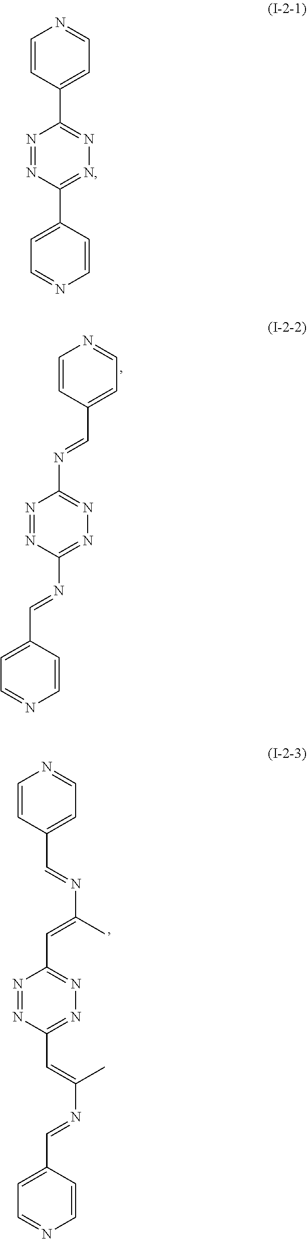 [SMILES: c1cc(-c2nnc(-c3ccncc3)nn2)ccn1 ; C(=N\c1nnc(/N=C/c2ccncc2)nn1)/c1ccncc1 ; CC(=C\c1nnc(/C=C(C)/N=C/c2ccncc2)nn1)/N=C/c1ccncc1]

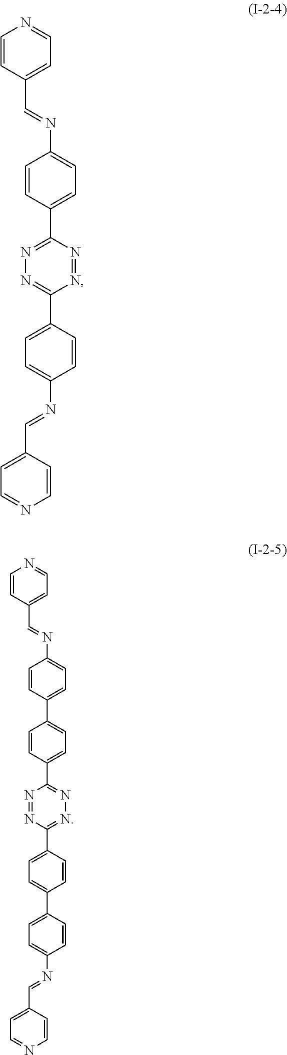 [SMILES: C(=N\c1ccc(-c2nnc(-c3ccc(/N=C/c4ccncc4)cc3)nn2)cc1)/c1ccncc1 ; C(=N\c1ccc(-c2ccc(-c3nnc(-c4ccc(-c5ccc(/N=C/c6ccncc6)cc5)cc4)nn3)cc2)cc1)/c1ccncc1]

The first ligand (I-3) can have, but is not limited to, a structure represented by one of Formula (I-3-1) to Formula (I-3-6):

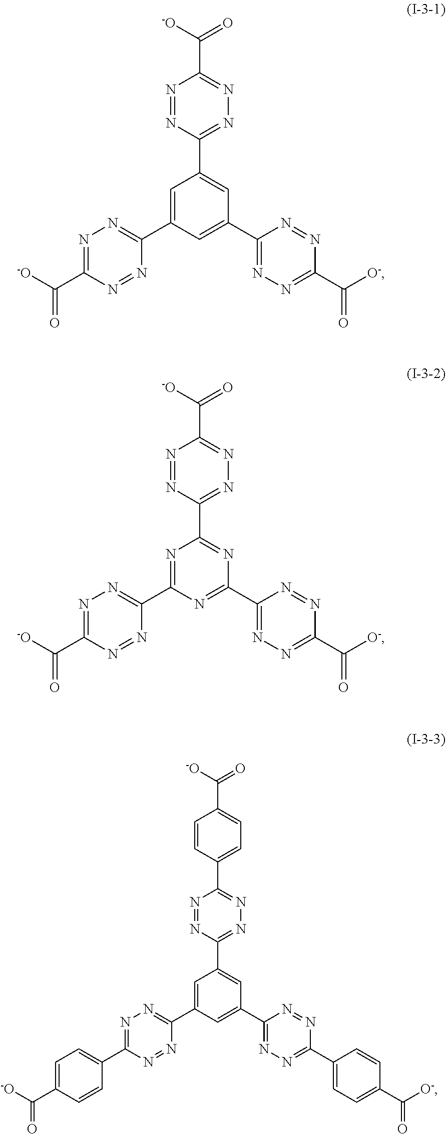

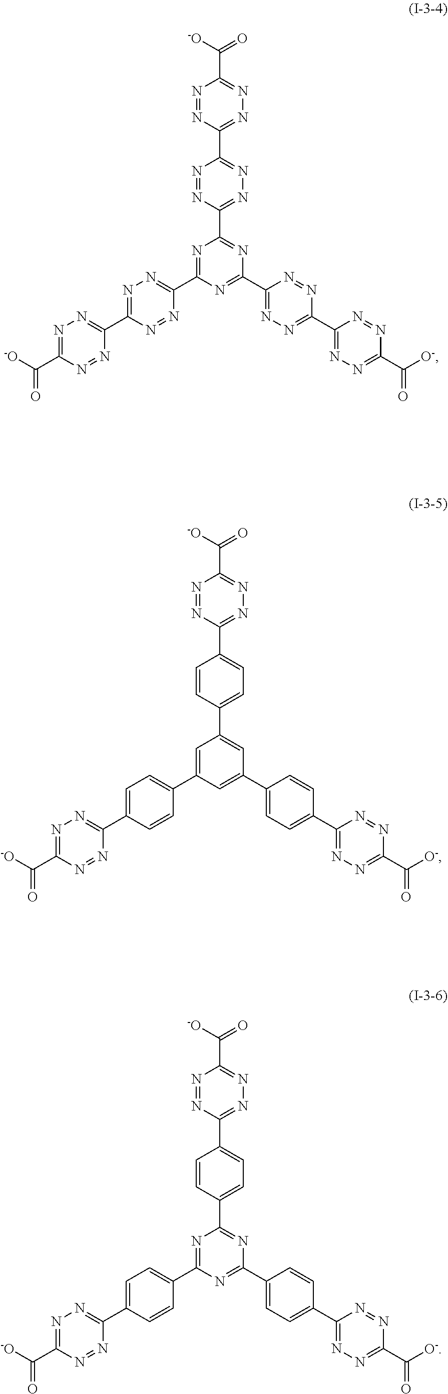

The first ligand (I-4) can have, but is not limited to, a structure represented by one of Formula (I-4-1) to Formula (I-4-3):

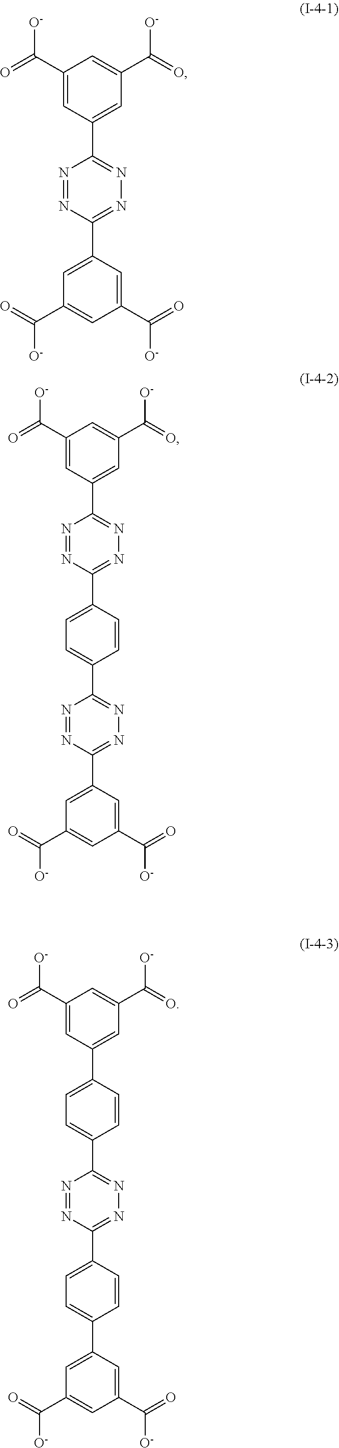 [SMILES: O=C([O-])c1cc(C(=O)[O-])cc(-c2nnc(-c3cc(C(=O)[O-])cc(C(=O)[O-])c3)nn2)c1 ; O=C([O-])c1cc(C(=O)[O-])cc(-c2nnc(-c3ccc(-c4nnc(-c5cc(C(=O)[O-])cc(C(=O)[O-])c5)nn4)cc3)nn2)c1 ; O=C([O-])c1cc(C(=O)[O-])cc(-c2ccc(-c3nnc(-c4ccc(-c5cc(C(=O)[O-])cc(C(=O)[O-])c5)cc4)nn3)cc2)c1]

The first ligand (I-5) can have, but is not limited to, a structure represented by one of Formula (I-5-1) to Formula (I-5-6):

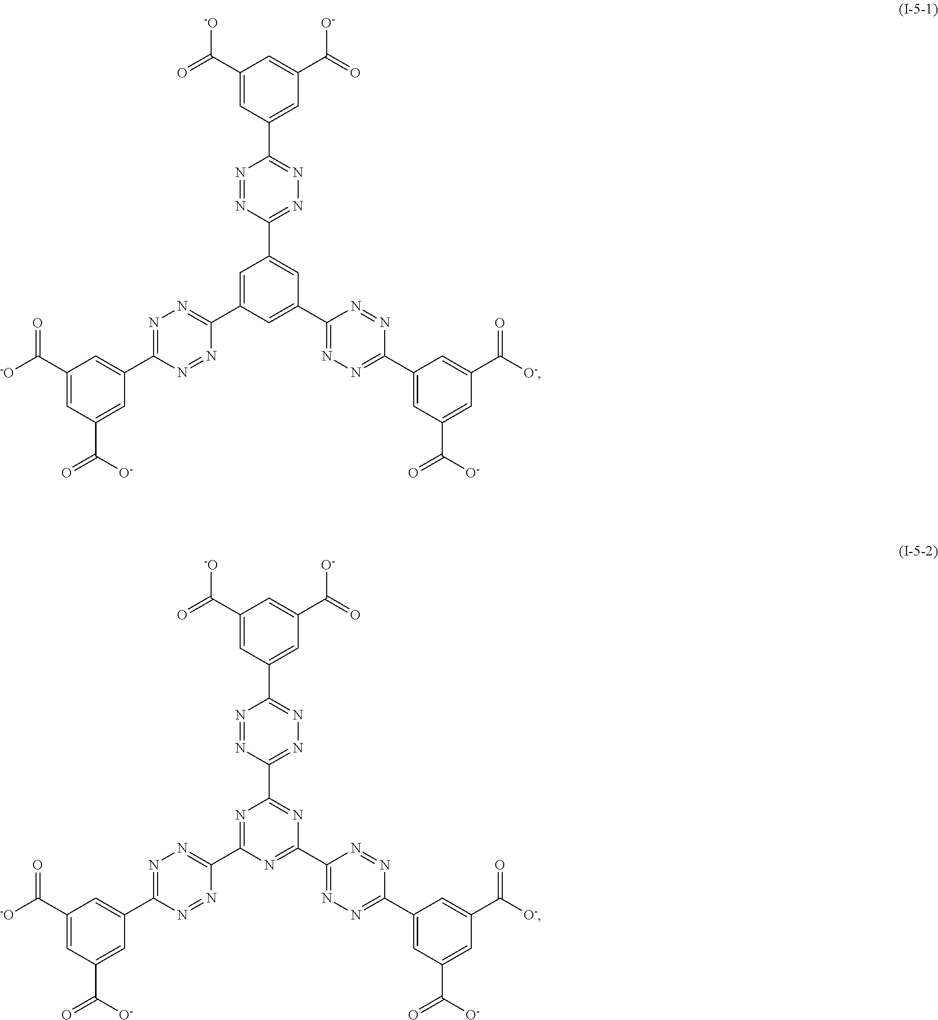

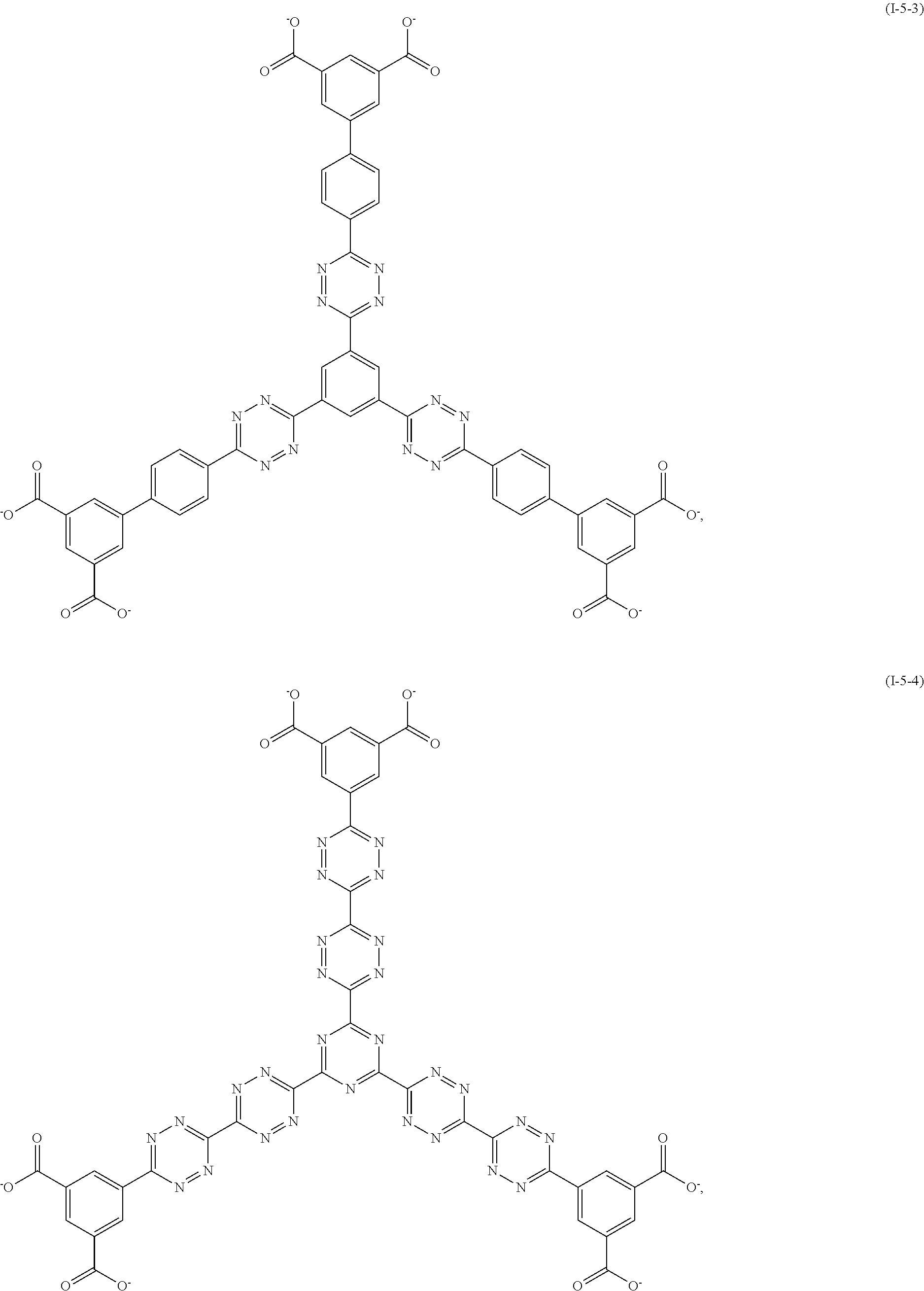

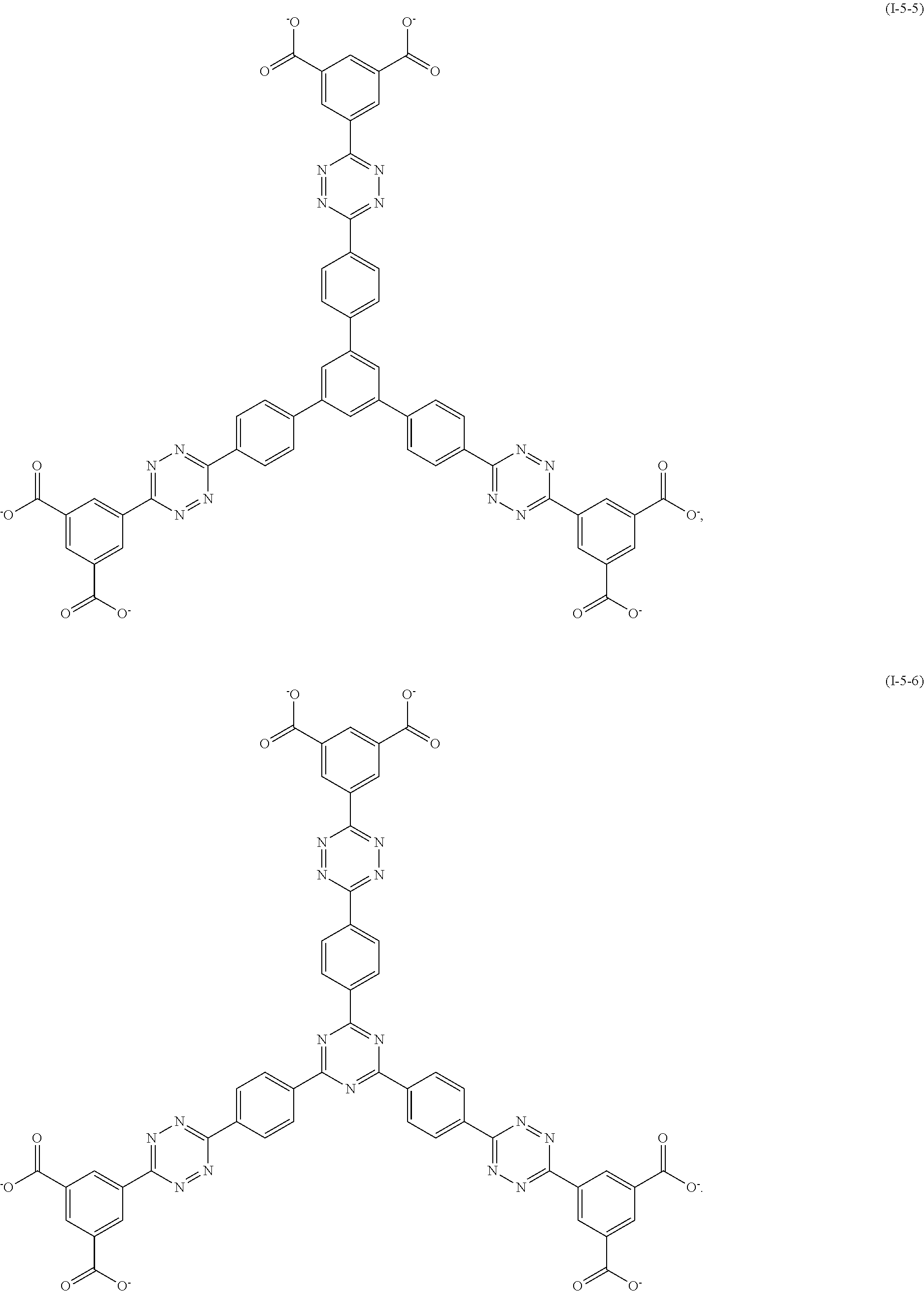

Each of the metal clusters includes at least one metal ion. The metal ion can be selected from the group consisting of Li⁺, Na⁺, K⁺, Rb⁺, Cs⁺, Be²⁺, Mg²⁺, Ca²⁺, Sr²⁺, Ba²⁺, Al³⁺, Ga³⁺, In³⁺, Sc³⁺, Y³⁺, Ti⁴⁺, Zr⁴⁺, Hf⁴⁺, V²⁺, V³⁺, V⁴⁺, Nb³⁺, Ta³⁺, Cr³⁺, Mo³⁺, Re²⁺, Re³⁺, Mn²⁺, Mn³⁺, Fe²⁺, Fe³⁺, Ru²⁺, Ru³⁺, Os²⁺, Os³⁺, Co²⁺, Co³⁺, Rh⁺, Rh²⁺, Ir⁺, Ir²⁺, Ni⁺, Ni²⁺, Pd⁺, Pd²⁺, Pt⁺, Pt²⁺, Cu⁺, Cu²⁺, Ag⁺, Au⁺, Zn²⁺, Cd²⁺ and Hg²⁺.

When the porous organic framework is a covalent organic framework, each of the first ligands can be provided by a compound having a structure represented by Formula (II-1), Formula (II-2) or Formula (II-3):

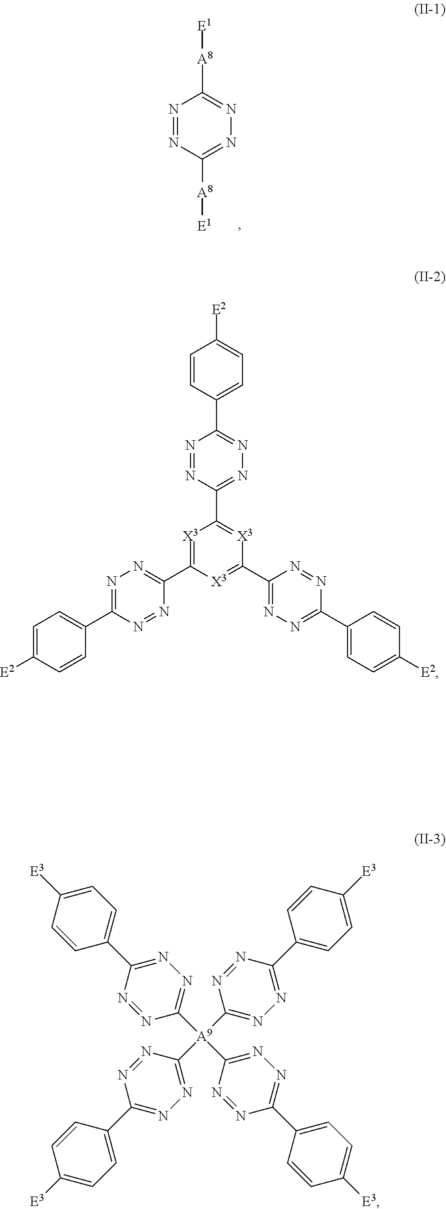

wherein each of A⁸ independently represents a single bond or a divalent organic group, A⁹ represents a tetravalent organic group, each of E¹, E² and E³ independently represents B(OH)₂, an amino group or an aldehyde group, and each of X³ independently represents N or C.

The compound (II-1) providing the first ligand can have, but is not limited to, a structure represented by one of Formula (II-1-1) to Formula (II-1-2):

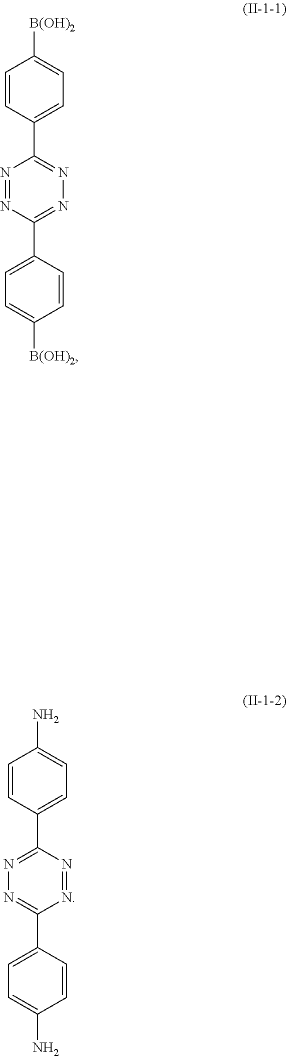 [SMILES: OB(O)c1ccc(-c2nnc(-c3ccc(B(O)O)cc3)nn2)cc1 ; Nc1ccc(-c2nnc(-c3ccc(N)cc3)nn2)cc1]

The compound (II-2) providing the first ligand can have, but is not limited to, a structure represented by one of Formula (II-2-1) to Formula (II-2-4):

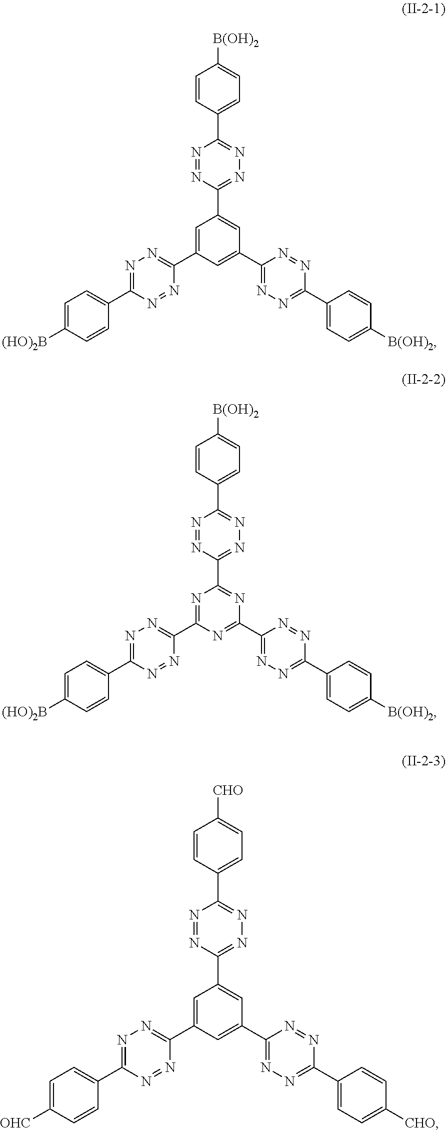 [SMILES: OB(O)c1ccc(-c2nnc(-c3cc(-c4nnc(-c5ccc(B(O)O)cc5)nn4)cc(-c4nnc(-c5ccc(B(O)O)cc5)nn4)c3)nn2)cc1 ; OB(O)c1ccc(-c2nnc(-c3nc(-c4nnc(-c5ccc(B(O)O)cc5)nn4)nc(-c4nnc(-c5ccc(B(O)O)cc5)nn4)n3)nn2)cc1 ; O=Cc1ccc(-c2nnc(-c3cc(-c4nnc(-c5ccc(C=O)cc5)nn4)cc(-c4nnc(-c5ccc(C=O)cc5)nn4)c3)nn2)cc1]

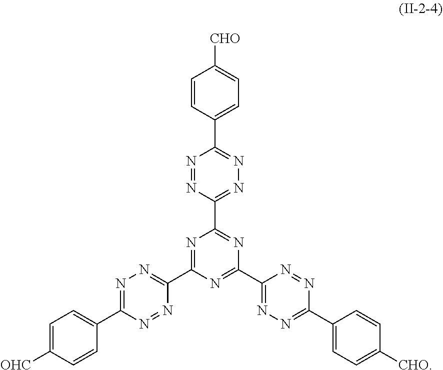 [SMILES: O=Cc1ccc(-c2nnc(-c3nc(-c4nnc(-c5ccc(C=O)cc5)nn4)nc(-c4nnc(-c5ccc(C=O)cc5)nn4)n3)nn2)cc1]

The compound (II-3) providing the first ligand can have, but is not limited to, a structure represented by one of Formula (II-3-1) to Formula (II-3-2):

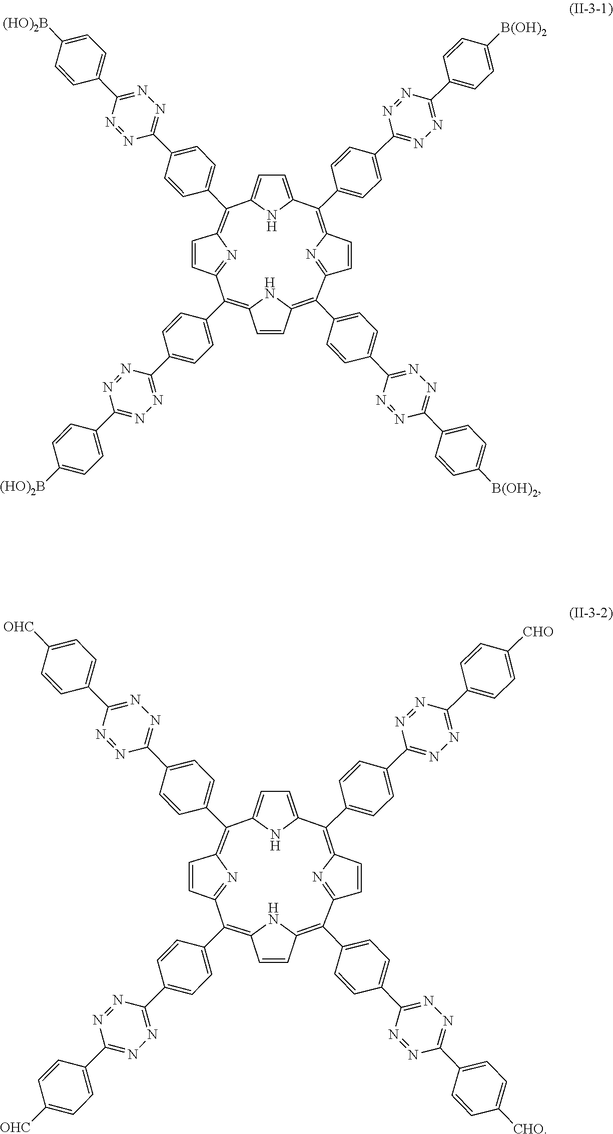 [SMILES: OB(O)c1ccc(-c2nnc(-c3ccc(-c4c5nc(c(-c6ccc(-c7nnc(-c8ccc(B(O)O)cc8)nn7)cc6)c6ccc([nH]6)c(-c6ccc(-c7nnc(-c8ccc(B(O)O)cc8)nn7)cc6)c6nc(c(-c7ccc(-c8nnc(-c9ccc(B(O)O)cc9)nn8)cc7)c7ccc4[nH]7)C=C6)C=C5)cc3)nn2)cc1 ; O=Cc1ccc(-c2nnc(-c3ccc(-c4c5nc(c(-c6ccc(-c7nnc(-c8ccc(C=O)cc8)nn7)cc6)c6ccc([nH]6)c(-c6ccc(-c7nnc(-c8ccc(C=O)cc8)nn7)cc6)c6nc(c(-c7ccc(-c8nnc(-c9ccc(C=O)cc9)nn8)cc7)c7ccc4[nH]7)C=C6)C=C5)cc3)nn2)cc1]

When the porous organic framework is the covalent organic framework, the porous organic framework can only include the first ligands. In this case, the compound providing the first ligand has a reactive functional group which is self-reactive, so that a plurality of compounds providing the first ligand can react with each other. As a result, a plurality of the first ligands are covalently connected with each other so as to assemble the covalent organic framework.

When the porous organic framework is the covalent organic framework, the porous organic framework can further include a plurality of second ligands, and one of the second ligands is covalently connected with one of the first ligands. For example, the compounds providing the first ligand and the compounds providing the second ligand can undergo a condensation polymerization reaction, so that the first ligands can be covalently connected with the second ligands. The second ligands can be provided by a compound including a plurality of hydroxyl groups, a plurality of amino groups or a plurality of aldehyde groups. For example, when the compounds providing the first ligand include reactive functional groups of —B(OH)₂, the compounds providing the second ligand can include reactive functional groups of —OH; when the compounds providing the first ligand include reactive functional groups of —OH, the compounds providing the second ligand can include reactive functional groups of —B(OH)₂; when the compounds providing the first ligand include reactive functional groups of —NH₂, the compounds providing the second ligand can include reactive functional groups of —CHO; when the compounds providing the first ligand include reactive functional groups of —CHO, the compounds providing the second ligand can include reactive functional groups of —NH₂. In other words, the kinds and the number of the reactive functional groups of the compounds providing the second ligand can be selected according to the kinds and the number of the reactive functional groups of the compounds providing the first ligand, so that the compounds providing the first ligand and the compounds providing the second ligand can undergo a reaction (such as a condensation reaction) so as to assemble the covalent organic framework.

The compound providing the second ligand can have a structure represented by one of Formula (III-1-1) to Formula (III-1-7), Formula (III-2-1) and Formula (III-2-2):

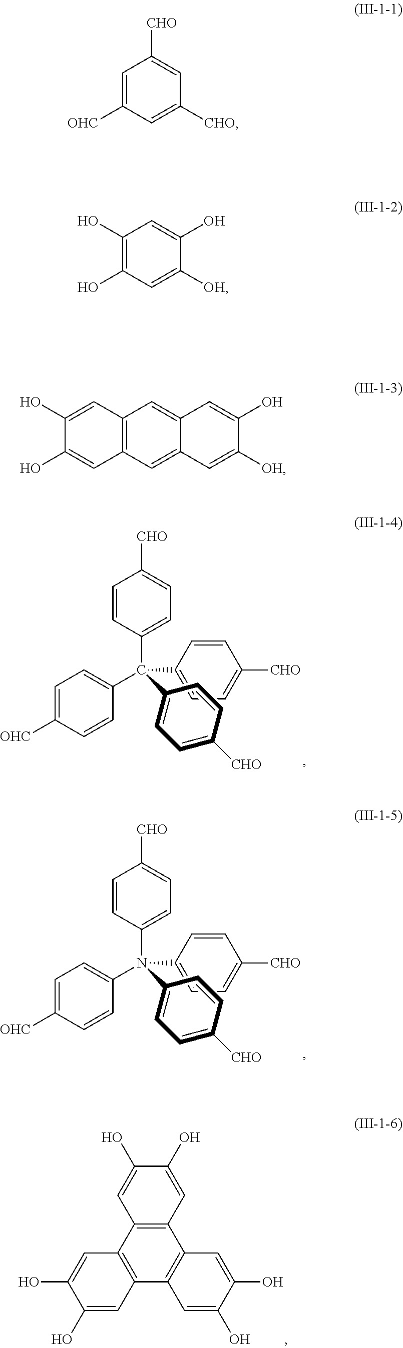

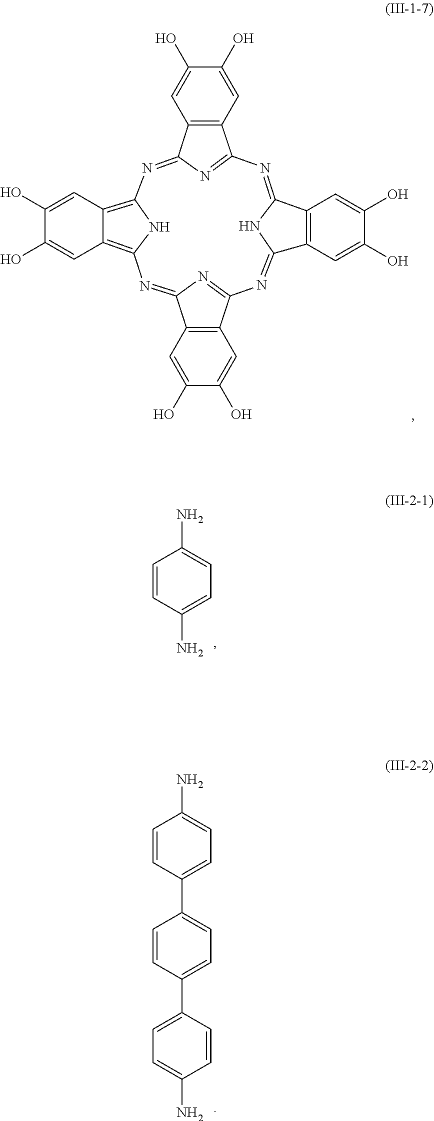 [SMILES: Oc1cc2c(cc1O)-c1nc-2nc2[nH]c(nc3nc(nc4[nH]c(n1)c1cc(O)c(O)cc41)-c1cc(O)c(O)cc1-3)c1cc(O)c(O)cc21 ; Nc1ccc(N)cc1 ; Nc1ccc(-c2ccc(-c3ccc(N)cc3)cc2)cc1]

Table 1 shows covalent organic frameworks COF1-COF33 and the start materials for assembling the same. The start materials refer to the compounds providing the first ligand and the compounds providing the second ligand which assemble each of the covalent organic frameworks COF1-COF33. For example, COF1 is self-assembled by the compounds providing the first ligand (II-1-1). COF2 is assembled by the compounds providing the first ligand (II-1-1) and the compounds providing the second ligand (III-1-6). COF6 is assembled by the compounds providing the first ligand (II-2-1), the compounds providing the first ligand (II-2-2) and the compounds providing the second ligand (III-1-2). The start materials of other covalent organic frameworks are shown in Table 1 and are not listed here one by one. Moreover, no matter the covalent organic framework is assembled only by the compounds providing the first ligand or is assembled by both of the compounds providing the first ligand and the compounds providing the second ligand, one or more kinds of the compounds providing the first ligand can be used, and one or more kinds of the compounds providing the second ligand can be used. Moreover, the compounds providing the first ligand, the compounds providing the second ligand and the covalent organic frameworks COF1-COF33 recited in the present disclosure are only exemplary, and the present disclosure are not limited thereto. The compounds providing the first ligand and the compounds providing the second ligand can be selected according to practical needs so as to assemble the covalent organic frameworks with different properties (such as different pore sizes and crystal structures).

TABLE 1

| covalent | compound providing | compound providing |
|---|---|---|
| organic framework | the first ligand | the second ligand |
| COF1 | (II-1-1) | |
| COF2 | (II-1-1) | (III-1-6) |
| COF3 | (II-1-1) | (III-1-7) |
| COF4 | (II-2-1) | (III-1-2) |
| COF5 | (II-2-2) | (III-1-2) |
| COF6 | (II-2-1), (II-2-2) | (III-1-2) |
| COF7 | (II-2-1) | (III-1-6) |
| COF8 | (II-2-2) | (III-1-6) |
| COF9 | (II-2-1), (II-2-2) | (III-1-6) |
| COF10 | (II-2-1) | (III-1-7) |
| COF11 | (II-2-2) | (III-1-7) |
| COF12 | (II-2-1), (II-2-2) | (III-1-7) |
| COF13 | (II-3-1) | (III-1-2) |
| COF14 | (II-3-1) | (III-1-3) |
| COF15 | (II-1-2) | (III-1-1) |
| COF16 | (II-2-3) | (III-2-1) |
| COF17 | (II-2-4) | (III-2-1) |
| COF18 | (II-2-3), (II-2-4) | (III-2-1) |
| COF19 | (II-2-3) | (III-2-2) |
| COF20 | (II-2-4) | (III-2-2) |
| COF21 | (II-2-3), (II-2-4) | (III-2-2) |
| COF22 | (II-2-3), (II-1-2) | |
| COF23 | (II-2-4), (II-1-2) | |
| COF24 | (II-2-3), (II-2-4), (II-1-2) | |
| COF25 | (II-2-3), (II-1-2) | (III-2-2) |
| COF26 | (II-2-4), (II-1-2) | (III-2-2) |
| COF27 | (II-2-3), (II-2-4), (II-1-2) | (III-2-2) |
| COF28 | (II-3-2) | (III-2-1) |
| COF29 | (II-3-2) | (III-2-2) |
| COF30 | (II-3-2), (II-1-2) | |
| COF31 | (II-3-2), (II-1-2) | (III-2-2) |
| COF32 | (II-1-2) | (III-1-4) |
| COF33 | (II-1-2) | (III-1-5) |

The reactive functional groups can refer to the groups that allow the compounds providing the first ligand to conduct a self-reaction or refer to the groups that allow the compounds providing the first ligand and the compounds providing the second ligand to react with each other.

According to present disclosure, the first ligand is an organic ligand that includes at least one tetrazine group, and the second ligand is an organic ligand that has no tetrazine group.

Each of the group donors can be a protoporphyrin IX. The protoporphyrin IX has a central structure which is similar to that of a chlorophyll molecule and a hemoglobin molecule, and can combine with metal ions. Therefore, the modified porous organic framework can be applied to catalysis, CO₂ carriers and O₂ carriers. The reaction equation of the protoporphyrin IX and the tetrazine group of the porous organic framework is shown in Table 2. Because the porous organic framework reacts with the protoporphyrin IX via the tetrazine group, other portion of the porous organic framework is omitted.

TABLE 2

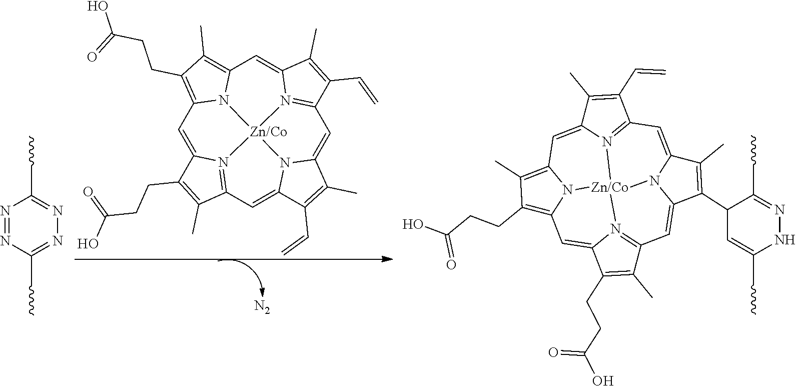

Each of the group donors can be a lipase. The lipase can hydrolyze triglycerides or fatty acid esters to glycerol and fatty acids. The lipase also can be the catalyst of ester synthesis and ester interesterification. Therefore, the lipase is widely used in the fields of chemical industry, medicine and food. The lipase has a ketone group which can react with the tetrazine group of the porous organic framework. Therefore, the porous organic framework can be modified by the lipase. Accordingly, the modified porous organic framework can be applied to the aforementioned fields. In general, the lipase can only be used once. However, when the lipase is modified to the porous organic framework, the lipase can be used repeatedly, which is favorable for enhancing the use efficiency.

Each of the group donors can have a structure represented by Formula (IV-1), Formula (IV-2) or Formula (IV-3):

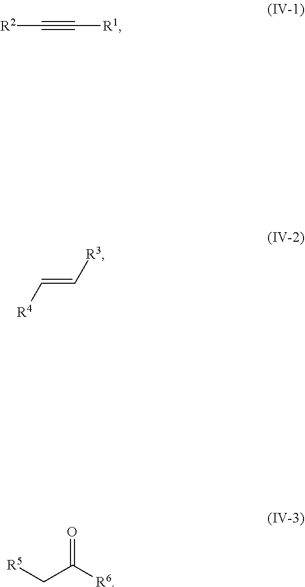

The reaction equations of the group donor (IV-1), the group donor (IV-2), the group donor (IV-3) and the tetrazine group of the porous organic framework are shown in Table 3. Because the porous organic framework reacts with the group donor (IV-1), the group donor (IV-2) or the group donor (IV-3) via the tetrazine group, other portion of the porous organic framework is omitted.

TABLE 3

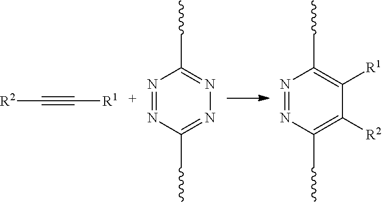

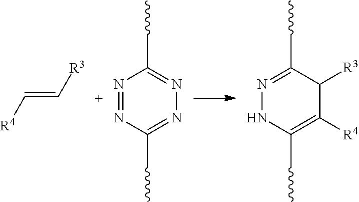

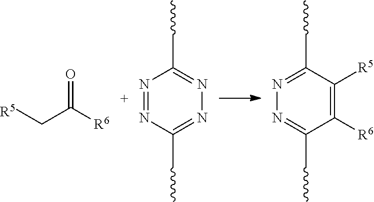

Each of R¹, R², R³, R⁴, R⁵ and R⁶ can independently represent H or a C₁-C₄₀ monovalent organic group. Alternatively, each of R¹, R², R³, R⁴, R⁵ and R⁶ can independently represent H, a C₁-C₄₀ alkyl group or a C₆-C₄₀ phenyl group. At least one H of the C₁-C₄₀ alkyl group can be substituted by NH₂, F, Cl, Br or I. At least one methylene group (CH₂) of the C₁-C₄₀ alkyl group can be substituted by NH or a carbonyl group. At least one H of the C₆-C₄₀ phenyl group can be substituted by NH₂, F, Cl, Br or I. At least one CH₂ of the C₆-C₄₀ phenyl group can be substituted by NH or a carbonyl group. The CH of a benzene ring of the C₆-C₄₀ phenyl group can be substituted by N. The C₆-C₄₀ phenyl group refers an aromatic group having a total of 6-40 carbon atoms and containing at least one phenyl group.

The group donor (IV-1) can have a structure represented by one of Formula (IV-1-1) to Formula (IV-1-10):

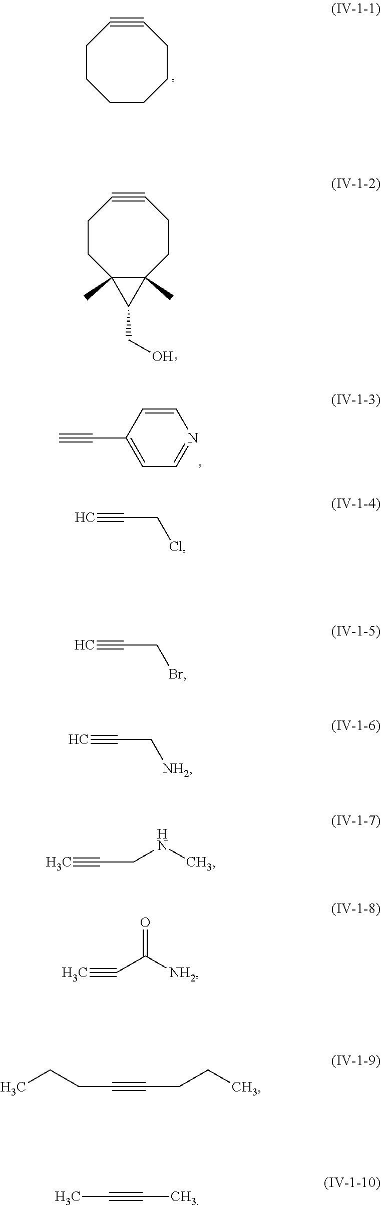

The group donor (IV-2) can be, but is not limited to, 1-octadecene or 2-propen-1-amine.

The group donor (IV-3) can be, but is not limited to, acetone.

In Step 110, the solvent of the mixed solution is for enhancing the solubility and chemical reactivity of organic groups. Therefore, a substance which can achieve the aforementioned functions can be the solvent of the mixed solution of the method for manufacturing a modified porous organic framework 100. The solvent of the mixed solution can be, but is not limited to, N,N-dimethylformamide (DMF), N,N-diethylformamide (DEF), methanol, ethanol, ethyl ether, acetone, dichloromethane, tetrahydrofuran (THF), toluene, pyridine or benzene. The aforementioned solvent can be used alone or simultaneously with any ratio when no chemical reaction generated therebetween after mixing.

According to one example of the present disclosure, the porous organic framework is formed by heating a mixture of 4,4′-(1,2,4,5-tetrazine-3,6-diyl)dibenzoic acid, aluminum chloride and N,N-diethylformamide, and each of the group donors is 1-octadecene.

The product of the method for manufacturing the modified porous organic framework 100, i.e., the modified porous organic framework, can be stored by immersing in a storage solvent. The storage solvent can be removed when the modified porous organic framework is subjected to the following application. For example, the storage solvent can be removed by heating. The storage solvent is for isolating the modified porous organic framework from the oxygen and moisture of the air so as to prolong the lifetime of the modified porous organic framework. Therefore, a substance which can achieve the aforementioned functions can be the storage solvent of the modified porous organic framework. The storage solvent can be identical to or different from the solvent of the mixing solution in Step 110 according to practical needs. The storage solvent can be, but is not limited to, N,N-diethylformamide or N,N-dimethylformamide.

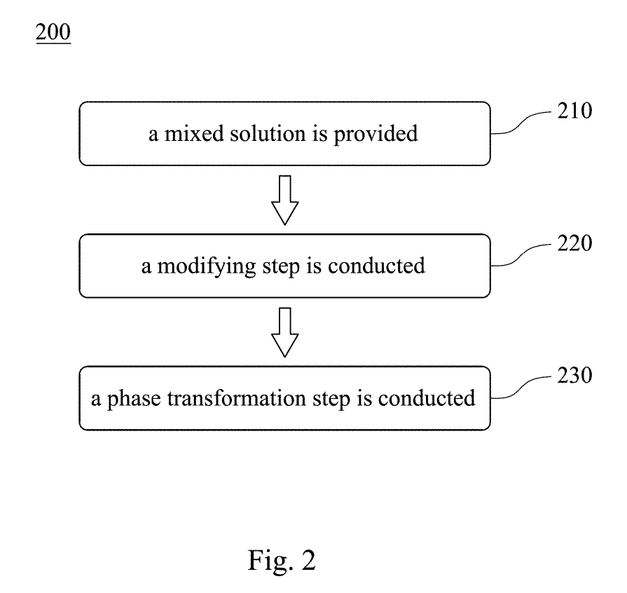

FIG. 2 is a flow diagram showing a method for manufacturing a modified porous organic framework 200 according to another embodiment of the present disclosure. In FIG. 2, the method for manufacturing the modified porous organic framework 200 includes Step 210, Step 220 and Step 230.

In Step 210, a mixed solution is provided. In Step 220, a modifying step is conducted. Step 210 and Step 220 can be the same as Step 110 and Step 120 in FIG. 1, respectively. Thus, a repeated description is omitted.

In Step 230, a phase transformation step is conducted, wherein the modified porous organic framework is immersed in another solvent for a solvent replacement (i.e., for replacing the original solvent for immersing the modified porous organic framework), then the modified porous organic framework is dried so as to obtain a modified porous organic framework with a different lattice structure. The original solvent refers to the solvent of the mixing solution or the storage solvent. The solvent used in the phase transformation step is different from the solvent of the mixing solution or the storage solvent. Specifically, the boiling point of the solvent used in the phase transformation step is lower than the boiling point of the solvent of the mixing solution, and is lower than the boiling point of the storage solvent. The solvent used in the phase transformation step can be, but is not limited to methanol, ethanol, 1-butanol, ether, acetone, dichloromethane, tetrahydrofuran, toluene, pyridine, benzene or ethyl ether. The aforementioned solvent can be used alone or simultaneously with any ratio when no chemical reaction generated therebetween after mixing. The modified porous organic framework can be dried by heating, so that the solvent used in the phase transformation step can be evaporated. With the phase transformation step, the lattice structure of the modified porous organic framework can be changed. In other words, the pore size of the modified porous organic framework can be changed, so that the application scope of the modified porous organic framework can be broadened. The solvent used in the phase transformation step can be selected according to the kinds of the modified porous organic frameworks. The temperature for drying the modified porous organic framework can be adjusted according to the kinds of the solvent used in the phase transformation step. Moreover, the order of Step 230 and Step 220 can be changed.

### Modified Porous Organic Framework

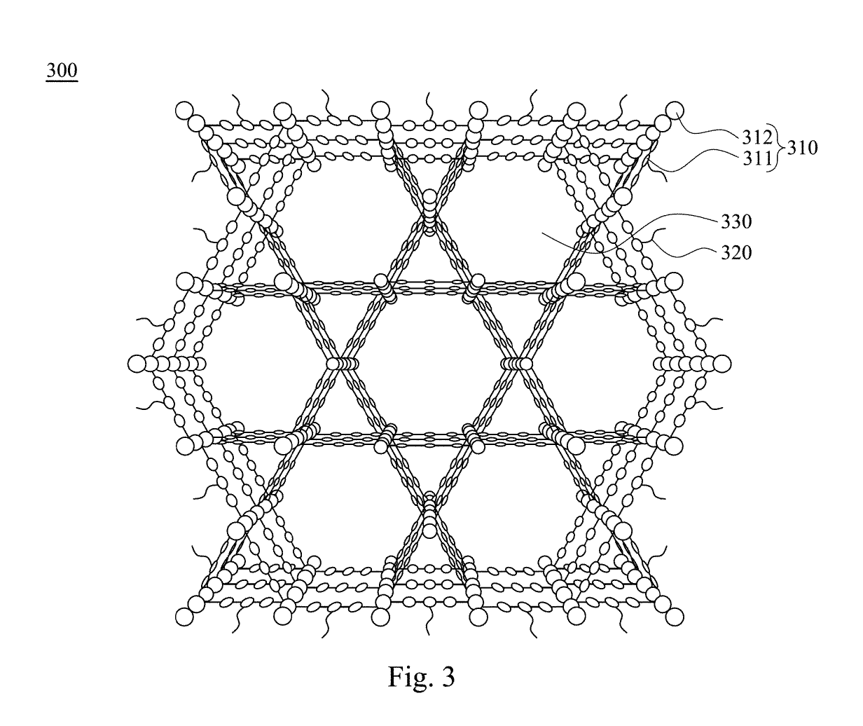

According to the present disclosure, a modified porous organic framework is provided. The modified porous organic framework is manufactured by the aforementioned method for manufacturing the modified porous organic framework. FIG. 3 is a schematic view showing a structure of a modified porous organic framework 300 according to further another embodiment of the present disclosure. In FIG. 3, the modified porous organic framework 300 includes a porous organic framework 310 and modifying groups 320 (provided by the group donors (not shown)). In FIG. 3, the porous organic framework 310 is a metal porous organic framework, which is only exemplary, and the present disclosure is not limited thereto. The porous organic framework 310 includes first ligands 311 and metal clusters 312. The modifying groups 320 are covalently connected with the porous organic framework 310. Furthermore, FIG. 3 is only schematic, which is for showing the relationship of the porous organic framework 310 and the modifying groups 320 of the modified porous organic framework 300. Therefore, the specific composition and the structure of the first ligands 311 and metal clusters 312 are not depicted. Furthermore, only a portion of the modified porous organic framework 300 is shown in FIG. 3. As shown in FIG. 3, a three-dimensional structure constructed by the first ligands 311 and the metal clusters 312 extends with repeated units (not labelled) and has pores 330. The number of the repeated units depends on the manufacturing conditions, so that only some repeated units are depicted. Furthermore, the pore size of the second layer and the third layer are reduced for providing the visual effect of extension, so that the porous organic framework 310 extending along the normal of the paper plane can be observed. In actual, the hexagonal pore and the triangular pore are hexagonal tubular structure and triangular tubular structure which extend along the normal of the paper plane. That is, in the real situation, the pore sizes of different layers are the same, when the view angle is along the normal of the paper plane, only the structure of the first layer (i.e., the topmost layer) can be observed. In FIG. 3, the porous organic framework 310 is a kge framework, which is only exemplary, and the present disclosure is not limited thereto. In other embodiment, the first ligands and the metal clusters can be changed so as to assemble a metal organic framework with desired lattice structure. Alternatively, the first ligands can be changed so as to self-assemble or coordinate with the second ligands to assemble a covalent organic framework. In FIG. 3, the number and the position of the modifying groups 320 are only exemplary. For the reason of conciseness and neatness, each of the first ligands 311 located at the topmost layer and the outer surface of the modified porous organic framework 300 is attached with a modifying group 320. However, in the real situation, the number and the position of the modifying groups 320 depend on the number and the position of the tetrazine group, the manufacturing conditions (such as the concentration, the reaction temperature and the reaction time), the pore size of the pore 330 and the size of the modifying group 320, etc. For example, when the size of the modifying group 320 is greater than the pore size of the pore 330, the first ligands 311 tend to be modified on the outer surface of the modified porous organic framework 300. That is, the space of the pore 330 is not occupied by the modifying group 320. On the contrary, when the size of the modifying group 320 is smaller than the pore size of the pore 330, probability of the first ligands 311 inside the modified porous organic framework 300 modified by the modifying group 320 is enhanced. That is, the space of the pore 330 can be occupied by the modifying group 320. In other words, the modified porous organic framework according to the present disclosure can be featured with different properties by selecting different kinds of the first ligands, the second ligands and the modifying groups, so that different application goals can be satisfied. Details of the modified porous organic framework, the first ligands, the second ligands and the metal clusters have been mentioned above, and are not repeated herein.

### Method for Manufacturing Porous Organic Framework Composite

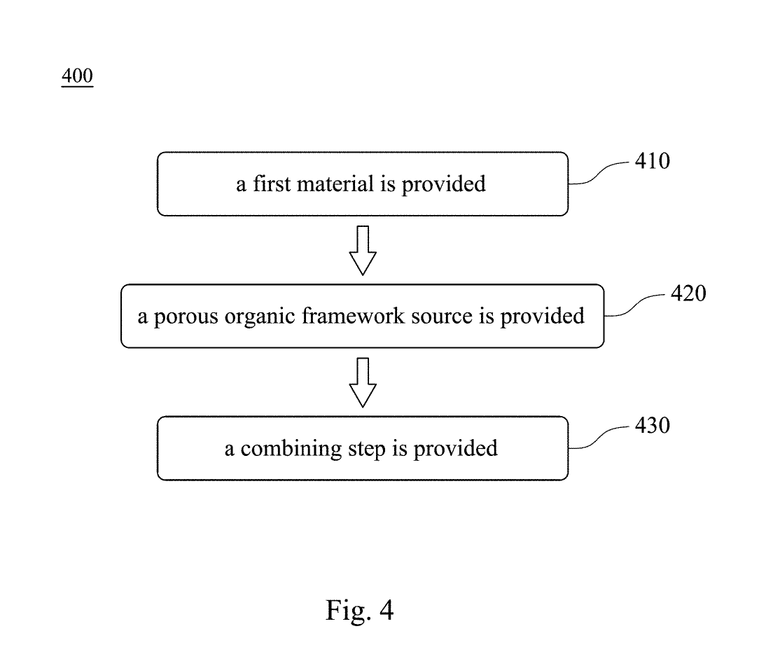

FIG. 4 is a flow diagram showing a method for manufacturing a porous organic framework composite 400 according to yet another embodiment of the present disclosure. In FIG. 4, the method for manufacturing a porous organic framework composite 400 includes Step 410, Step 420 and Step 430.

In Step 410, a first material is provided, wherein the first material includes a plurality of reactive groups, and the reactive groups are alkenyl groups, alkynyl groups, aldehyde groups, ketone groups or a combination thereof.

In Step 420, a porous organic framework source is provided, wherein the porous organic framework source includes a porous organic framework or a precursor of the porous organic framework, the porous organic framework and the precursor of the porous organic framework includes a plurality of first ligands, and each of the first ligands includes at least one tetrazine group.

In Step 430, a combining step is provided, wherein at least one of the reactive groups of the first material is reacted with at least one of the tetrazine groups of the first ligands, so that the porous organic framework and the first material are covalently connected, whereby the porous organic framework composite is obtained. The combining step can be conducted at a temperature ranging from 100° C. to 130° C. for 12 hours to 24 hours. However, the present disclosure is not limited thereto, the reaction temperature and the reaction time can be adjusted according to the kinds of the porous organic framework, the kinds of the precursor of the porous organic framework and the kinds of the first material.

The precursor of the porous organic framework can be reactants for manufacturing the porous organic framework. For example, when the porous organic framework is a metal organic framework, the precursor of the porous organic framework can be the compounds providing the first ligand and the compounds providing the metal source of the metal clusters. In other words, the porous organic framework can be assembled in advance, then the tetrazine groups and the reactive groups react with each other, so that the porous organic framework and the first material are combined. Alternatively, the compounds providing the first ligand of the precursor of the porous organic framework can react with the reactive groups via the tetrazine groups, so that the compounds providing the first ligand can be firstly combined with the first material then coordinated with other components of the precursor of the porous organic framework to assemble the porous organic framework.

With the porous organic framework including the tetrazine groups, and the reactive groups of the first material being alkenyl groups, alkynyl groups, aldehyde groups, ketone groups or a combination thereof, the porous organic framework can be combined with the first material through a click reaction so as to feature the porous organic framework with different properties, which is simple and can broaden the application scope of the porous organic framework. Furthermore, with the first material having its own functionalities and the porous organic framework having its own functionalities, the porous organic framework composite according to the present disclosure can present the functionalities of both of the first material and the porous organic framework. Accordingly, it is favorable to manufacture different kinds of novel materials. Therefore, the kinds of the first materials can be selected according to practical demands, so that the porous organic framework composite with different properties can be manufactured for satisfying different application goals.

Details of the porous organic framework have been mentioned above, and are not repeated herein.

The porous organic framework composite can be a layered structure, the first material can be a substrate, and the reactive groups are disposed on a surface of the substrate. Therefore, the porous organic framework composite has the advantage of immobilization, which is favorable for the applications of gas separation and catalysis. The substrate can be a glass substrate or a silicon wafer substrate.

According to the porous organic framework composite, the first material can be a carbon material, and the reactive groups can be alkenyl groups. For example, the carbon material can be C₆₀, a carbon tube or graphene. When the carbon material with small size is selected, the porous organic framework composite can be prepared as a carbon quantum dot. As such, the porous organic framework composite can have long-term stability of illumination and excellent ability for tuning light color, which has the potential for the application of photoelectric field.

### Porous Organic Framework Composite

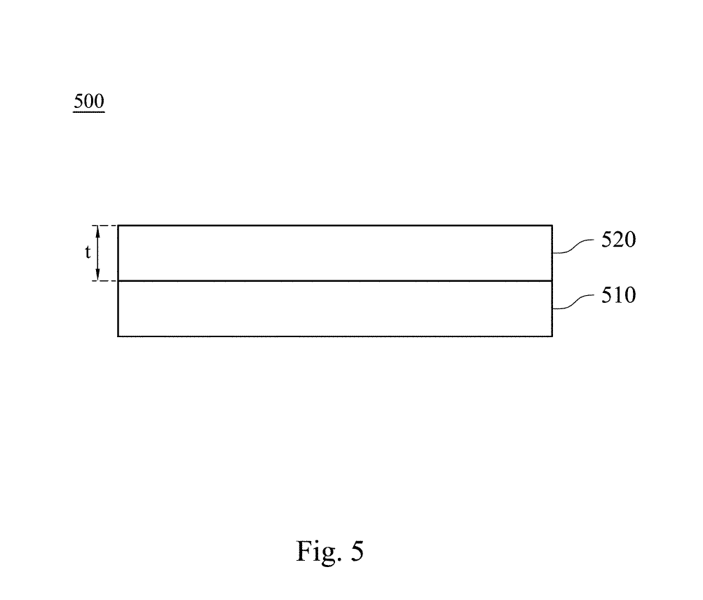

According to the present disclosure, a porous organic framework composite is provided. The porous organic framework composite is manufactured by the aforementioned method for manufacturing the porous organic framework composite. FIG. 5 is a schematic view showing a structure of a porous organic framework composite 500 according to yet another embodiment of the present disclosure. In FIG. 5, the porous organic framework composite 500 includes a first material 510 and a porous organic framework 520. In the embodiment of FIG. 5, the porous organic framework composite 500 is a layered structure, and the porous organic framework 520 is layered on a surface of the first material 510. However, the porous organic framework composite 500 in FIG. 5 is only exemplary, and the present disclosure is not limited thereto. In other embodiments, the first material can be disposed on a surface or in the pore of the porous organic framework. Furthermore, FIG. 5 is only schematic, which is for showing the relationship of the porous organic framework 520 and first material 510. Therefore, the specific structure of the porous organic framework 520 is not depicted. The porous organic framework composite 500 according to the present disclosure can be featured with different properties by selecting different kind of the first material 510 and different kind of the porous organic framework 520, so that different application goals can be satisfied. Furthermore, when a thickness of the porous organic framework 520 is t, the following condition can be satisfied: 0<t≤100 μm.

### Measuring Methods of Properties of Modified Porous Organic Framework and Porous Organic Framework Composite

1. The measuring method of PXRD: a sample (i.e. the modified porous organic framework, the porous organic framework composite or the unmodified porous organic framework of examples) with an amount of 3 mg to 5 mg is disposed in a sample container of the PXRD instrument (model: D8 Focus, Bruker) and is pressed into a thin sheet. Then the sample is scanned with a scanning speed of 2°/min, and the scanning angle is from 2.5° to 40° (A=1.54178 Å, 40 kV, 40 mA).

2. The measuring method of Fourier transform infrared (FT-IR) spectrum: the sample and KBr are mixed in a mass ratio of 1 to 100 to form a mixture. The mixture is grinded to form a homogeneous phase and is pressed into a pellet. The pellet is disposed in a Fourier transform infrared spectrometer (model: Nicolet 6700, Thermo Scientific) and is scanned. The scanning times is 64 times.

3. The measuring method of contact angle: the sample is pressed into a round pellet having a horizontal plane. A water droplet is dropped on the horizontal plane. Light rays are parallelly projected on the horizontal plane according to the design principle of the instrument, and the picture is captured by the camera of the instrument (model of the instrument is WV-CP-480 SDIII, Panasonic).

4. The measuring method of SEM image: the sample is prepared in the form of the standard sample of SEM, then is disposed in the SEM (model: JSM-7600F, JEOL) to observe the micro structure of the sample.

5. The measuring method of nitrogen adsorption: a sample with an amount of 15 mg is activated and is grinded into finer powders then put into a sample tube. The sample tube is installed in a degas pore of an instrument (model: ASAP 2020) then is heated at 180° C. under vacuum (10⁻⁵ torr) for 12 hours, so that the water and solvent in the pores of the sample can be removed. The weight of the sample which has been removed the water and the solvent is about 60 mg. Follow by placing the sample tube at a sample port, wherein the nitrogen adsorption capacity of the sample is measured by immersing the sample tube in liquid nitrogen (77K) with a volumetric method. The measured range is as follows: 1.00×10⁻⁶≤P/P₀≤1.00. The adsorption isotherms are obtained by plotting the nitrogen adsorption volume (cm³/g) on Y axis and the partial pressure (P/P₀) on X axis. The adsorption isotherms can be transformed into adsorption curves by programs, then the pore distribution diagram, the information of BET area and the information of Langmuir area can be obtained with other software (such as OriginalPro 2016). The sample can be activated by immersing the sample in DMF and standing for one day, then the DMF is replaced by ether for three times, and follow by drying the sample at 70° C. for 2 hours.

6. The measuring method of the lipase activity: the principle of the measuring method is as follows. The nitrophenyl easer substrate, such as p-nitrophenyl palmitate (p-NPP) can be hydrolyzed by the lipase so as to generate p-nitrophenyl (p-NP) and fatty acids (in this example, palmitic acids). The absorbance of p-NP at the wavelength 405 nm is measured. The lipase activity can be calculated by performing an analysis in a 96-well microtiter plate. The definition of the activity unit (U) of the lipase is as follows. An activity unit is the amount of enzyme used for generating 1 μmol of p-NP per minute by hydrolyzing.

### EXAMPLES/COMPARATIVE EXAMPLES

Example 1: modified porous organic framework AlTz53-C18. The manufacturing method is as follows. A mixture of 0.235 mmole AlCl₃, 0.18 mmole 1,2,4,5-tetrazine-3,6-dicarboxylic acid (H₂TZDB) and 5.0 ml DEF is heated at 120° C. for 1 day. The product is washed with 2.0 ml DMF for 3 times so as to obtain the porous organic framework AlTz53. The porous organic framework AlTz53 is kept storage by immersing in DMF till conducting the following experiments.

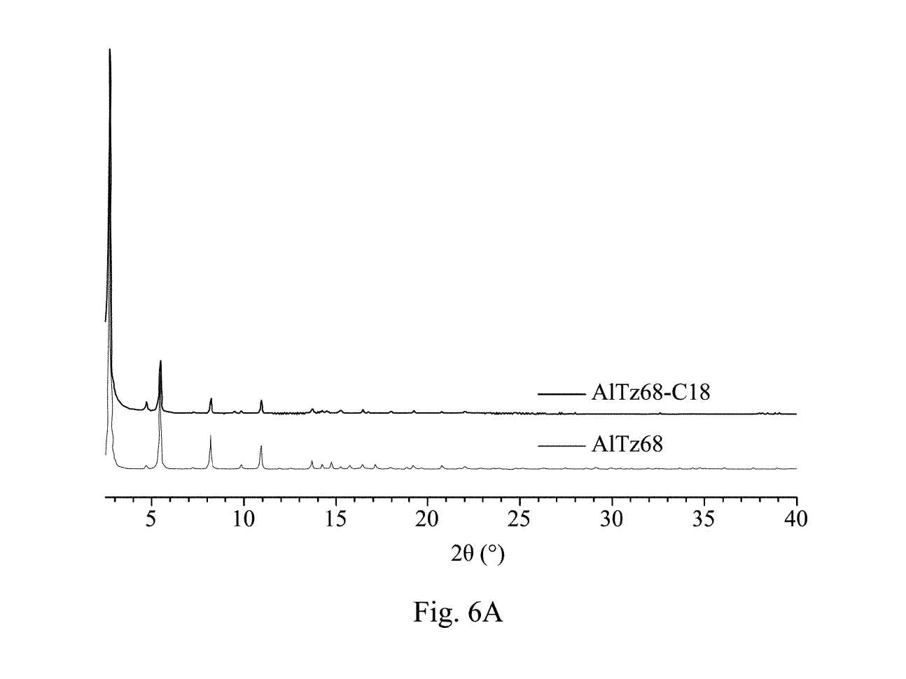

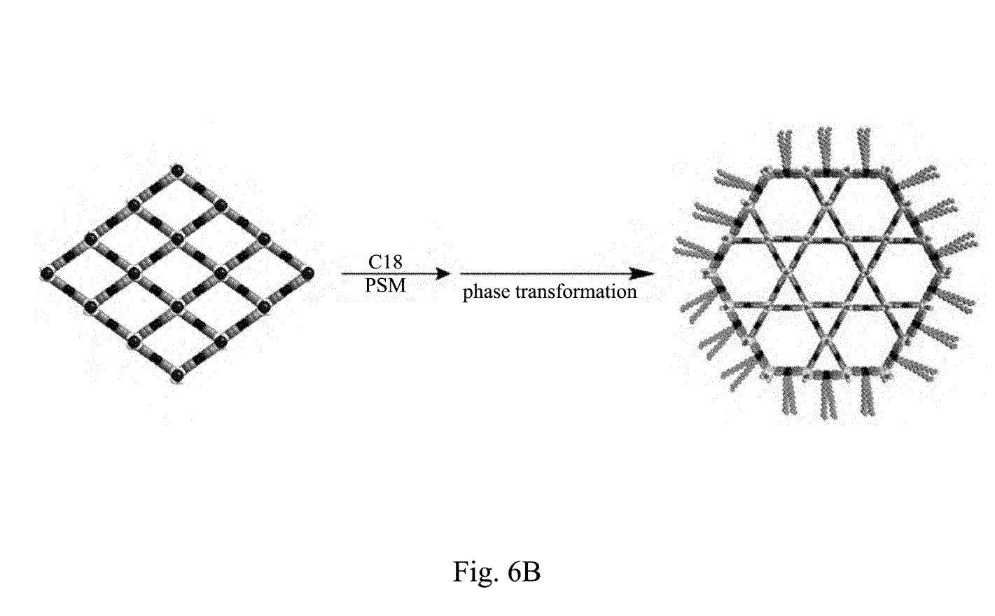

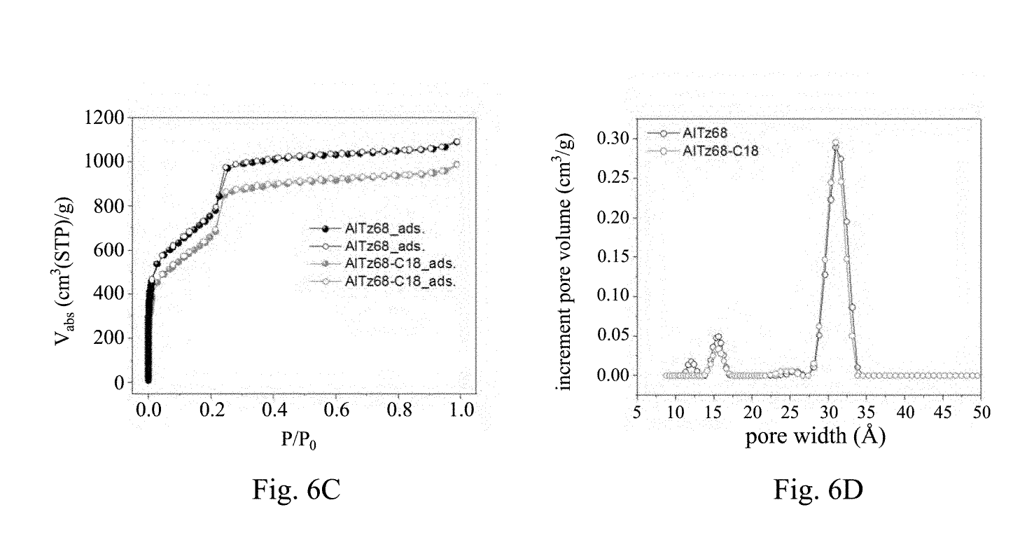

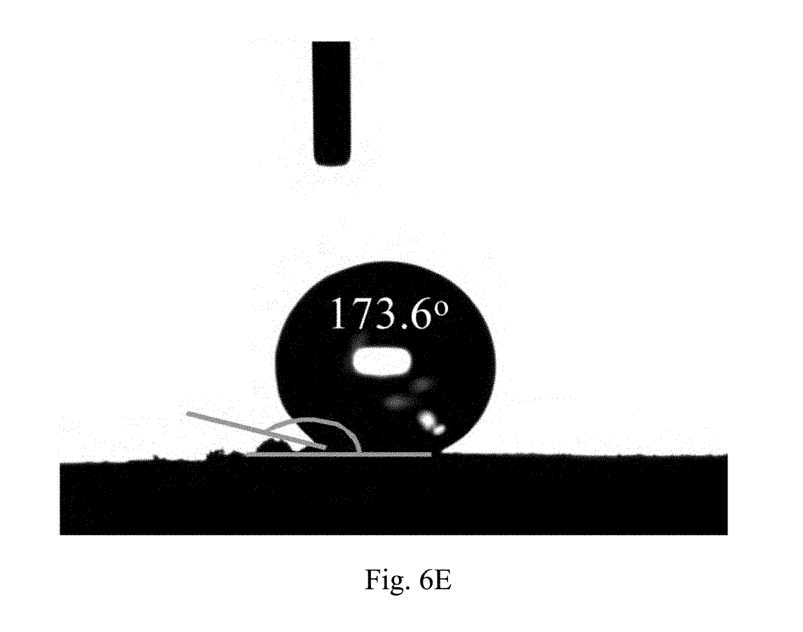

A mixture of 10.0 mg AlTz53, 3.0 ml DMF and 2.0 ml 1-octadecene is heated at 50° C. for 1 hour so as to synthesize the modified porous organic framework AlTz53-C18, then the DMF is removed by heating at 80° C. for 1 hour so as to obtain the modified porous organic framework AlTz53-C18. The porous organic framework AlTz53 is a sra network (shown in FIG. 6B). The reaction equation of the modifying step of Example 1 is shown in Table 4.

TABLE 4

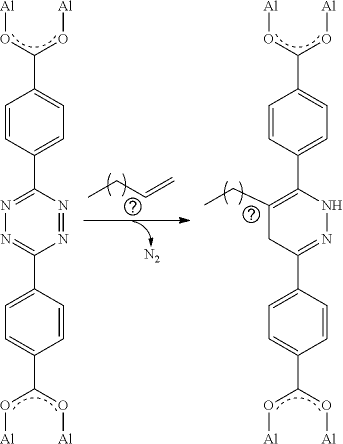

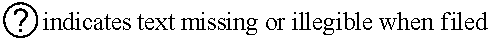

Because the porous organic framework AlTz53 reacts with the 1-octadecene via the tetrazine group, only one of the first ligands of the porous organic framework AlTz53 is shown. Furthermore, as shown in Table 4, after the reaction of the tetrazine group and the 1-octadecene, a cetyl group is modified on the porous organic framework AlTz53. In other words, the modifying group of Example 1 is the cetyl group.

Example 2: modified porous organic framework AlTz68-C18. The manufacturing method is as follows. A mixture of 10.0 mg AlTz53 (manufacturing method thereof shown in Example 1), 3.0 ml DMF and 2.0 ml 1-octadecene is heated at 50° C. for 1 hour so as to synthesize the modified porous organic framework AlTz53-C18.

The modified porous organic framework AlTz53-C18 is immersed in 3.0 ml ether for a solvent replacement, which is repeated three times. That is, the original solvent (herein, DMF) is replaced by ether. Then the modified porous organic framework AlTz53-C18 is immersed in ether, a height of the ether is 0.5 cm higher than that of the modified porous organic framework AlTz53-C18. The mixture of the modified porous organic framework AlTz53-C18 and ether is put in an oven and is heated at 75° C. for 1 hour, so that the modified porous organic framework AlTz68-C18 is obtained.

In Example 2, the porous organic framework AlTz53 is firstly conducted with a modifying step, then is conducted with a phase transformation step. The modifying step of Example 2 is identical to that of Example 1 and thus can refer to Table 4.

The porous organic framework AlTz68 can be obtained as follows. The porous organic framework AlTz53 is immersed in ether for a solvent replacement, which is repeated three times. A height of the ether is 0.5 cm higher than that of the modified porous organic framework AlTz53. The mixture of the modified porous organic framework AlTz53 and ether is put in an oven and is heated at 75° C. for 1 hour, so that the porous organic framework AlTz68 is obtained. Comparing to Example 2, the porous organic framework AlTz68 is obtained by only applying the phase transformation step to the porous organic framework AlTz53, and the modifying step is omitted. The porous organic framework AlTz68 can be the contrast of Example 2.

FIG. 6A is a diagram showing PXRD results of the porous organic framework AlTz68 and the modified porous organic framework AlTz68-C18. As shown in FIG. 6A, the structure of the modified porous organic framework AlTz68-C18 is the same as that of the porous organic framework AlTz68. In other words, in Example 2, the modifying groups are successfully modified to the porous organic framework AlTz68, and the structure of the porous organic framework AlTz68 is not changed.

FIG. 6B is a schematic view showing a structure of a starting material and a product of Example 2. It should be stated that FIG. 6B is only schematic, which is for showing the lattice structures of the starting material and the product of Example 2, and the positions of the modifying groups. Therefore, the specific composition and the structure of the first ligands, the metal clusters and the modifying groups are not depicted. The starting material of Example 2 is the porous organic framework AlTz 53, which is a sra network. After the modifying step and the phase transformation step, the modified porous organic framework AlTz68-C18 is obtained. Both of the structure of the porous organic framework AlTz68 and the modified porous organic framework AlTz68-C18 are kge frameworks. It shows that the lattice structure of the porous organic framework is changed by the phase transformation step. In Example 2, the porous organic framework AlTz 53 has pores with identical widths. However, the modified porous organic framework AlTz68-C18 has triangular pores (not labelled) with a smaller width and hexagonal pores (not labelled) with a larger width. Furthermore, because of the relationship between the length of the modifying group, i.e., the cetyl group, and the pore size of the porous organic framework AlTz 53, the cetyl group is favorably modified on the surface of the modified porous organic framework AlTz68-C18. Accordingly, it is favorable for maintaining the porosity of the modified porous organic framework AlTz68-C18. In FIG. 6B, PSM is abbreviation of the phrase “Post-Synthetic Modification”. That is, the modifying step in Example 2 is a kind of post-synthetic modification.

Please refer to FIG. 6C, FIG. 6D and Table 5. FIG. 6C shows nitrogen adsorption isotherms of the porous organic framework AlTz68 and Example 2, wherein the Y axis represents the nitrogen absorption volume per mass unit (V_{abs}), and the unit thereof is cm³(STP)/g, the X axis represents partial pressure (P/P₀). FIG. 6D shows pore size distributions of the porous organic framework AlTz68 and Example 2, wherein the Y axis represents the increment pore volume, and the unit thereof is cm³/g, the X axis represents pore width, and the unit thereof is Å. Table 5 shows the pore information obtained by the analysis of software.

TABLE 5

| | AlTz68 | AlTz68-C18 |
|---|---|---|
| Specific surface area | 2832.7 m²/g | 2500.4 m²/g |
| Langmuir area | 4604.8 m²/g | 4132.1 m²/g |
| Single pore volume | 1.69 cm³/g | 1.53 cm³/g |
| Total adsorption capacity | 1090.3 cm³/g | 986.2 cm³/g |

As shown in FIG. 6C, FIG. 6D and Table 5, after modifying, the loss of the specific surface area is not excessive. There are only a few loss of micropores, and the mesopores have almost no loss.

FIG. 6E shows a measurement result of a contact angle of Example 2. As shown in FIG. 6E, the contact angle of Example 2 is 173.6 degrees, which shows that Example 2 has superhydrophobic property. Furthermore, the contact angle of the porous organic framework AlTz68 is measured and is 0 degrees (not shown), which shows that the porous organic framework AlTz68 has superhydrophilic property. According to the measurement results of contact angle of Example 2 and the porous organic framework AlTz68, the property of the porous organic framework can be changed by modifying the modifying group thereto, which can broaden the application scope of the porous organic framework.

It is known that the moisture sensitivity limits the application of the porous organic framework. The moisture sensitivity caused the degradation of the porous organic framework in a moisture environment. With the method for manufacturing the modified porous organic framework according to the present disclosure, a superhydrophilic porous organic framework can be transformed into a superhydrophobic porous organic framework. The water stability is enhanced significantly, which is favorable for practical industrial application.

Example 3: modified porous organic framework AlTz68-C18′. The manufacturing method is as follows. The porous organic framework AlTz53 (manufacturing method thereof shown in Example 1) with an amount of 10 mg is immersed in 3.0 ml ether for a solvent replacement, which is repeated three times. Then the porous organic framework AlTz53 is immersed in ether, a height of the ether is 0.5 cm higher than that of the porous organic framework AlTz53. The mixture of the porous organic framework AlTz53 and ether is put in an oven and is heated at 75° C. for 1 hour, so that the porous organic framework AlTz68 is obtained.

The porous organic framework AlTz68 is washed with 3.0 ml ether for three times and then immersed in ether with a volume about 3.0 ml, then 2.0 ml 1-octadecene is added therein to form a mixture. The mixture is heated at 30° C. for 1 hour so as to synthesize the modified porous organic framework AlTz68-C18′. The modified porous organic framework AlTz68-C18′ is washed with ether and then immersed in ether. A height of the ether is 0.5 cm higher than that of the porous organic framework AlTz68-C18′. The mixture of the porous organic framework AlTz68-C18′ and ether is put in an oven and is heated at 75° C. for 1 hour, so that the porous organic framework AlTz68-C18′ is obtained. In Example 3, the porous organic framework AlTz53 is firstly conducted with a phase transformation step, then is conducted with a modifying step.

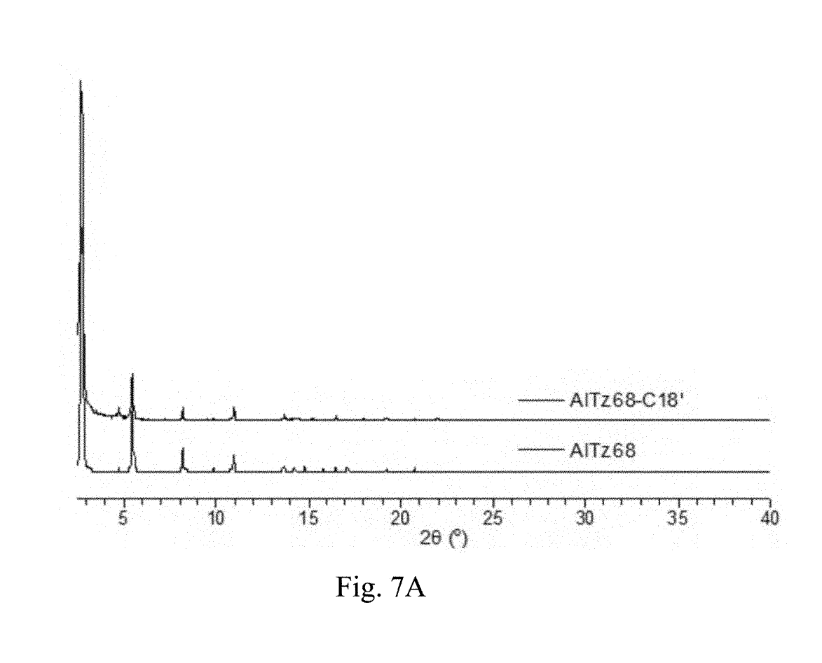

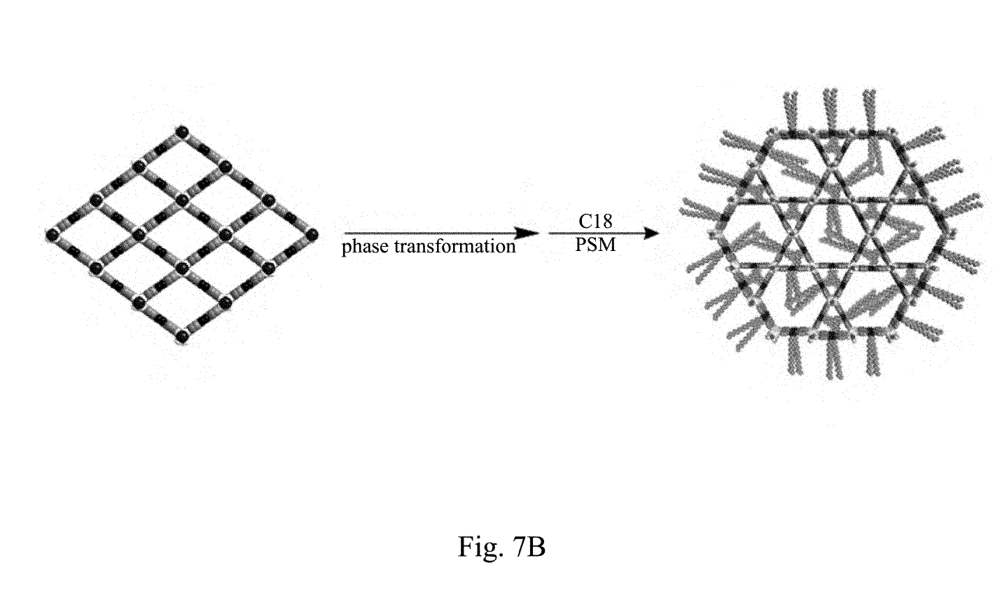

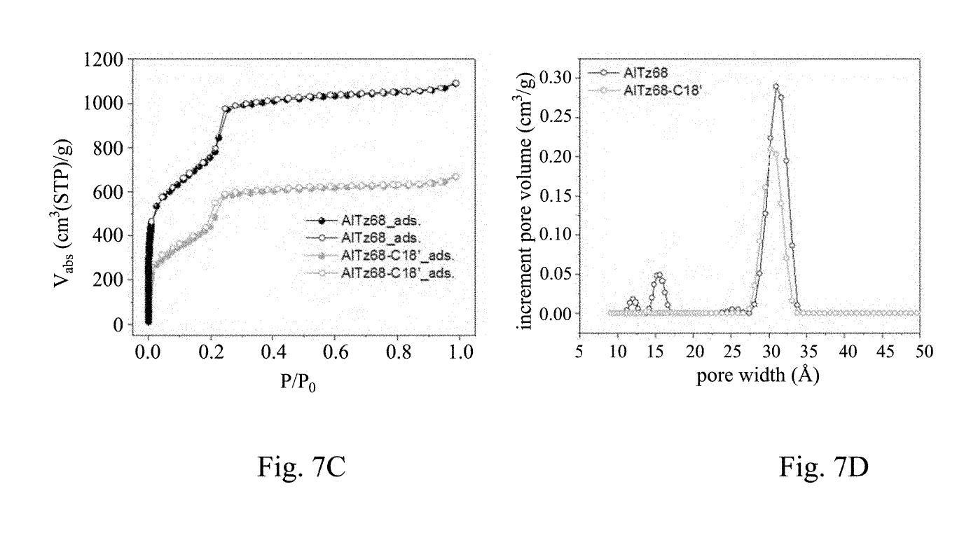

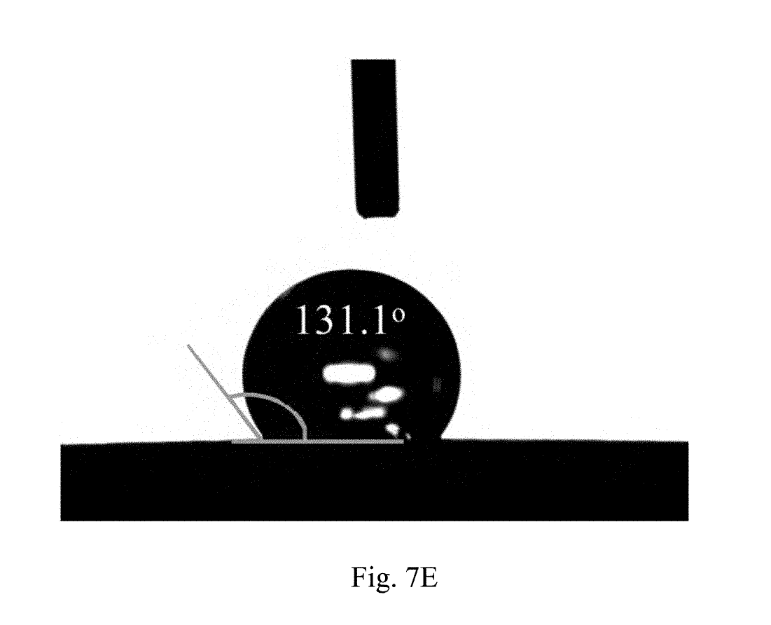

FIG. 7A is a diagram showing PXRD results of the porous organic framework AlTz68 and the modified porous organic framework AlTz68-C18′. As shown in FIG. 7A, the structure of the modified porous organic framework AlTz68-C18′ is the same as that of the porous organic framework AlTz68. In other words, in Example 3, the modifying groups are successfully modified to the porous organic framework AlTz68, and the structure of the porous organic framework AlTz68 is not changed.

FIG. 7B is a schematic view showing a structure of a starting material and a product of Example 3. It should be stated that FIG. 7B is only schematic, which is for showing the lattice structures of the starting material and the product of Example 3, and the positions of the modifying groups. Therefore, the specific composition and the structure of the first ligands, the metal clusters and the modifying groups are not depicted. The starting material of Example 3 is the porous organic framework AlTz53, which is a sra network. After the phase transformation step and the modifying step, the modified porous organic framework AlTz68-C18′ is obtained. Both of the structure of the porous organic framework AlTz68 and the modified porous organic framework AlTz68-C18′ are kge frameworks. It shows that the lattice structure of the porous organic framework can be changed by the phase transformation step.

Furthermore, because of the relationship between the length of the modifying group, i.e., the cetyl group, and the pore size of the porous organic framework AlTz68, the cetyl group can be modified both on the surface and in the pores of the modified porous organic framework AlTz68-C18′. Accordingly, the porosity of the modified porous organic framework AlTz68-C18′ is smaller than that of the modified porous organic framework AlTz68-C18. According to the present disclosure, whether the modifying group disposed in the pores of the porous organic framework or not can be decided by choosing the order of the modifying step and the phase transformation step or the kind of the porous organic framework and the kind of modifying groups, so that the porosity of the modified porous organic framework can be adjusted according to practical demands.

Please refer to FIG. 7C, FIG. 7D and Table 6. FIG. 7C shows nitrogen adsorption isotherms of the porous organic framework AlTz68 and Example 3. FIG. 7D shows pore size distributions of the porous organic framework AlTz68 and Example 3. The definitions and units of Y axes and X axes of FIG. 7C and FIG. 7D are identical to that of FIG. 6C and FIG. 6D, respectively. Table 6 shows the pore information obtained by the analysis of the measurements of FIG. 7C and FIG. 7D by software.

TABLE 6

| | AlTz68 | AlTz68-C18′ |
|---|---|---|
| Specific surface area | 2832.7 m²/g | 1698.8 m²/g |
| Langmuir area | 4604.8 m²/g | 2813.8 m²/g |
| Single pore volume | 1.69 cm³/g | 1.03 cm³/g |
| Total adsorption capacity | 1090.3 cm³/g | 668.5 cm³/g |

As shown in FIG. 7C, FIG. 7D and Table 6, due to the modifying groups occupying the space of pores, the losses of the specific surface area and the mesopores of the modified porous organic framework AlTz68-C18′ are slightly higher than that of the modified porous organic framework AlTz68-C18.

FIG. 7E shows a measurement result of a contact angle of Example 3. As shown in FIG. 7E, the contact angle of Example 3 is 131.1 degrees, which shows that Example 3 has hydrophobic property. According to the measurement results of contact angle of the porous organic framework AlTz68, Example 2 and Example 3, the property of the porous organic framework can be changed by modifying the modifying group thereto. Furthermore, the hydrophobic degree of the modified porous organic framework can be adjusted by changing the order of the phase transformation step and the modifying step, or the kind of the modifying group. Therefore, the modified porous organic framework with more diversified properties can be provided for different applications.

Example 4: modified porous organic framework ZrTz68-C18. The manufacturing method is as follows. A mixture of 0.045 mmole ZrCl₄, 0.045 mmole H₂TZDB, 0.01 ml trifluoroacetic acid and 2.5 ml DMF is heated at 120° C. for 2 days. The solid product is washed with 2.0 ml DMF for 3 times then immersed in DMF for 2 days, and further immersed in CHCl₃ for another 2 days. Afterword, the mixture of the solid product and the CHCl₃ is heated at 90° C. for 12 hours so as to obtain the porous organic framework ZrTz68. The porous organic framework ZrTz68 is kept storage by immersing in DMF till conducting the following experiments.

A mixture of 10.0 mg ZrTz53, 5.0 ml CHCl₃ and 2.0 ml 1-octadecene is conducted at 60° C. for 1 hour so as to synthesize the modified porous organic framework ZrTz68-C18, then the CHCl₃ is removed by heating at 70° C. for 1 hour so as to obtain the modified porous organic framework ZrTz68-C18.

According to the experimental analysis, the porous organic framework ZrTz68-C18 of Example 4 includes two kinds of repeated units, which form pores of tetrahedron and pores of octahedron, respectively. The main difference between Example 4 and Examples 2-3 is the metal sources which provide the metal clusters used in manufacturing AlTz68 and ZrTz68, and the structures of the porous organic framework are different thereby. That is, the porous organic framework with different structure can be obtained by using different precursor of the porous organic framework. Therefore, the kind of the precursor of the porous organic framework can be selected to feature the porous organic framework with a proper structure (for example, a desired pore shape and pore size), so as to satisfy practical demands. Moreover, because of the relationship between the length of the modifying group, i.e., the cetyl group, and the pore size of the porous organic framework ZrTz68, the cetyl group is favorably modified on the surface of the modified porous organic framework ZrTz68-C18. Accordingly, it is favorable for maintaining the porosity of the modified porous organic framework ZrTz68-C18.

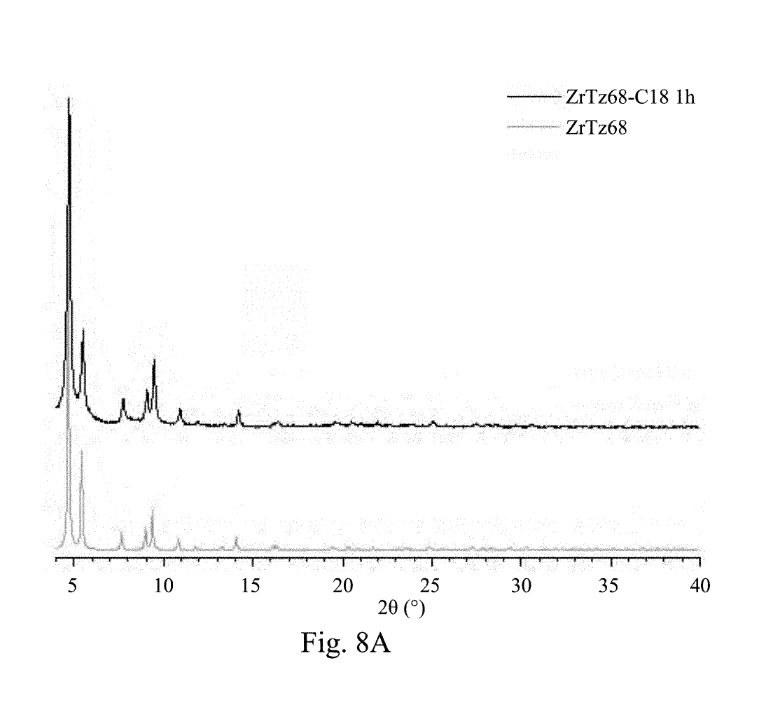

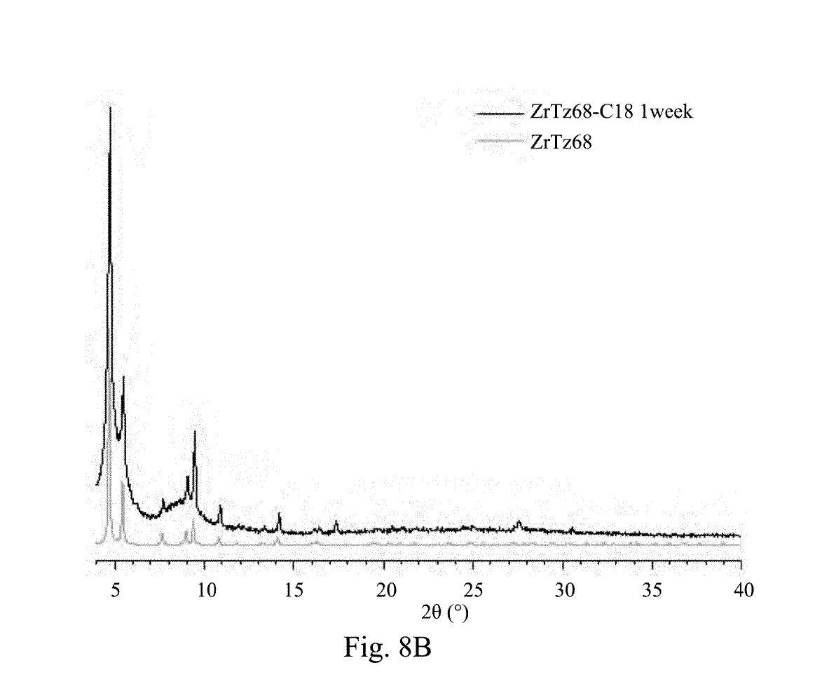

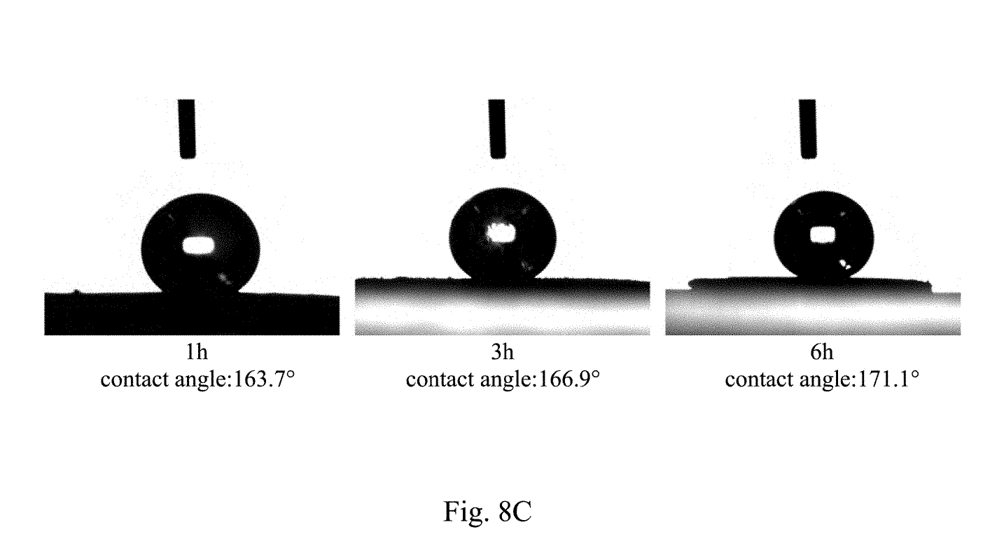

FIG. 8A is a diagram showing PXRD results of a porous organic framework ZrTz68 and the modified porous organic framework ZrTz68-C18, wherein “1 h” refers to the time of the modifying step. FIG. 8B is another diagram showing PXRD results of the porous organic framework ZrTz68 and the modified porous organic framework ZrTz68-C18. Specifically, FIG. 8B are the PXRD results which are measured after the porous organic framework ZrTz68 and the modified porous organic framework ZrTz68-C18 of FIG. 8A being placed in the air for 1 week (i.e., the meaning of “1 week” in FIG. 8B). As shown in FIG. 8A, the structure of the modified porous organic framework ZrTz68-C18 is the same as that of the porous organic framework ZrTz68. In other words, in Example 4, the modifying groups are successfully modified to the porous organic framework ZrTz68, and the structure of the porous organic framework ZrTz68 is not changed. Comparing FIG. 8A with FIG. 8B, the structure of the modified porous organic framework ZrTz68-C18 is maintained after being placed in the air for one week, which shows that the modified porous organic framework ZrTz68-C18 has excellent air stability and moisture stability. Accordingly, it is favorable for practical industrial application.

FIG. 8C shows measurement results of contact angles of Example 4, Example 5 and Example 6. Example 4, Example 5 and Example 6 are all modified porous organic framework ZrTz68-C18, wherein the time of the modifying step of Example 5 and the time of the modifying step of Example 6 are different from that of Example 4, other steps and details of Example 5 and Example 6 are the same as that of Example 4. In Example 4, the time of the modifying step is 1 hour (1 h). In Example 5, the time of the modifying step is 3 hours (3 h). In Example 6, the time of the modifying step is 6 hours (6 h). In FIG. 8C, the contact angle of Example 4 is 163.7 degrees, the contact angle of Example 5 is 166.9 degrees and the contact angle of Example 6 is 171.1 degrees. It shows that the modified porous organic framework ZrTz68-C18 of Example 4, Example 5 and Example 6 all have the superhydrophobic property. Furthermore, when the time of the modifying step is increased, the superhydrophobic property is more obvious. As shown in FIG. 8C, the method for manufacturing the modified porous organic framework according to the present disclosure can control the modifying degree by adjusting the time of the modifying step. Accordingly, the hydrophilic/hydrophobic degree of the final product, i.e., the modified porous organic framework can be controlled.

Example 7: modified porous organic framework AlTz68-pyridine. The manufacturing method is as follows. The porous organic framework AlTz53 (manufacturing method thereof shown in Example 1) with an amount of 10 mg is immersed in 3.0 ml ether for a solvent replacement, which is repeated three times. Then the porous organic framework AlTz53 is immersed in ether, a height of the ether is 0.5 cm higher than that of the porous organic framework AlTz53. The mixture of the porous organic framework AlTz53 and ether is put in an oven and is heated at 75° C. for 1 hour, so that the porous organic framework AlTz68 is obtained.

The porous organic framework AlTz68 is washed with 3.0 ml methanol for three times and then immersed in methanol with a volume about 3.0 ml, then 10.0 ml 4-ethynylpyridine is added therein to form a mixture. The mixture is heated at 50° C. for 2 hours so as to synthesize the modified porous organic framework AlTz68-pyridine. The modified porous organic framework AlTz68-pyridine is washed with ether and then immersed in ether. A height of the ether is 0.5 cm higher than that of the porous organic framework AlTz68-pyridine. The mixture of the porous organic framework AlTz68-pyridine and ether is put in an oven and is heated at 75° C. for 1 hour, so that the porous organic framework AlTz68-pyridine is obtained. In Example 7, the porous organic framework AlTz53 is firstly conducted with a phase transformation step, then is conducted with a modifying step.

The reaction equation of the modifying step of Example 7 is shown in Table 7.

TABLE 7

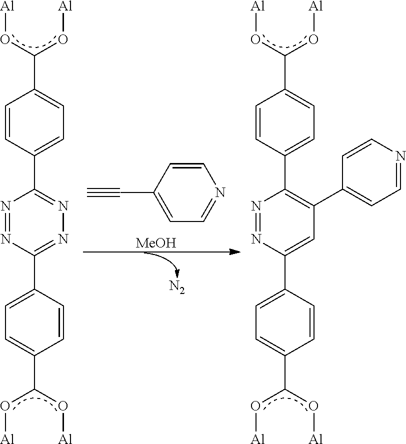

Because the porous organic framework AlTz68 reacts with the 4-ethynylpyridine via the tetrazine group, only one of the first ligands of the porous organic framework AlTz68 is shown. Furthermore, as shown in Table 7, after the reaction of the tetrazine group and the 4-ethynylpyridine, a pyridyl group is modified on the porous organic framework AlTz68. In other word, the modifying group of Example 7 is the pyridyl group.

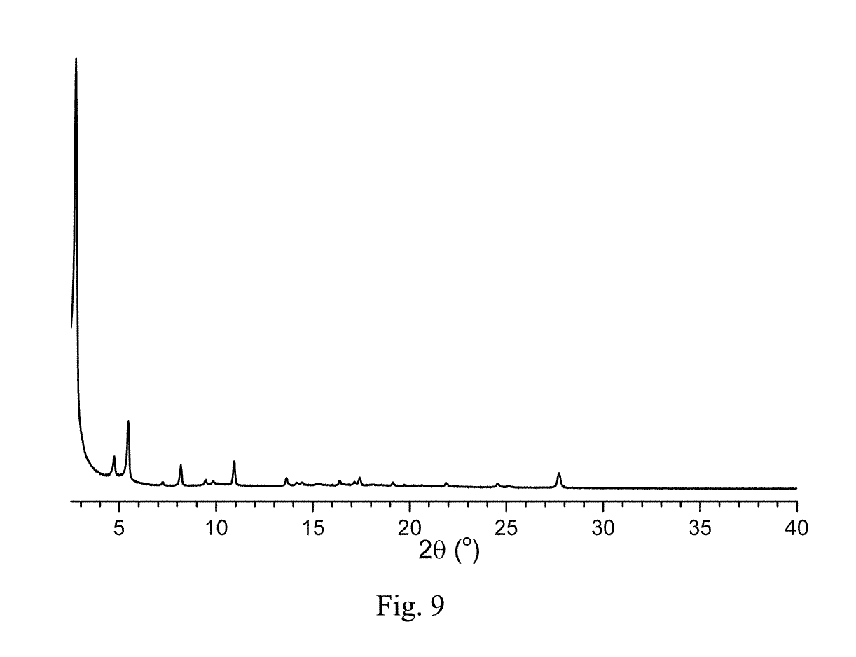

FIG. 9 is a diagram showing a PXRD result of the Example 7. As shown in FIG. 9, the structure of the modified porous organic framework AlTz68-pyridine is the same as that of the porous organic framework AlTz68. In other words, in Example 7, the modifying groups are successfully modified to the porous organic framework AlTz68, and the structure of the porous organic framework AlTz68 is not changed.

Example 8: modified porous organic framework AlTz68-methyl amide. The manufacturing method is as follows. The porous organic framework AlTz53 (manufacturing method thereof shown in Example 1) with an amount of 10 mg is immersed in 3.0 ml ether for a solvent replacement, which is repeated three times. Then the porous organic framework AlTz53 is immersed in ether, a height of the ether is 0.5 cm higher than that of the porous organic framework AlTz53. The mixture of the porous organic framework AlTz53 and ether is put in an oven and is heated at 75° C. for 1 hour, so that the porous organic framework AlTz68 is obtained.

The porous organic framework AlTz68 is washed with 3.0 ml ether for three times and then immersed in diethyl ether with a volume about 3.0 ml, then 2.0 ml 2-propen-1-amine is added therein to form a mixture. The mixture is heated at 50° C. for 2 hours so as to synthesize the modified porous organic framework AlTz68-methyl amide. The modified porous organic framework AlTz68-methyl amide is washed with 3.0 ml ether for three times and then immersed in ether. A height of the ether is 0.5 cm higher than that of the porous organic framework AlTz68-methyl amide. The mixture of the porous organic framework AlTz68-methyl amide and ether is put in an oven and is heated at 75° C. for 1 hour, so that the porous organic framework AlTz68-methyl amide is obtained. In Example 8, the porous organic framework AlTz53 is firstly conducted with a phase transformation step, then is conducted with a modifying step.

The reaction equation of the modifying step of Example 8 is shown in Table 8.

TABLE 8

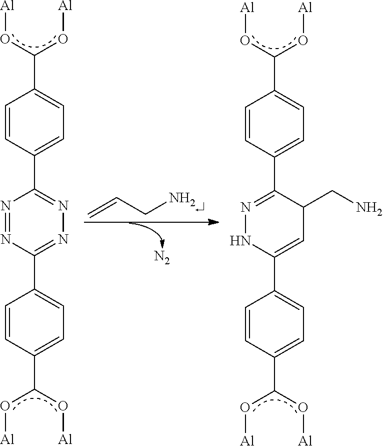

Because the porous organic framework AlTz68 reacts with the 2-propen-1-amine via the tetrazine group, only one of the first ligands of the porous organic framework AlTz68 is shown. Furthermore, as shown in Table 8, after the reaction of the tetrazine group and the 2-propen-1-amine, —CH₂NH₂ is modified on the porous organic framework AlTz68. In other word, the modifying group of Example 8 is —CH₂NH₂.

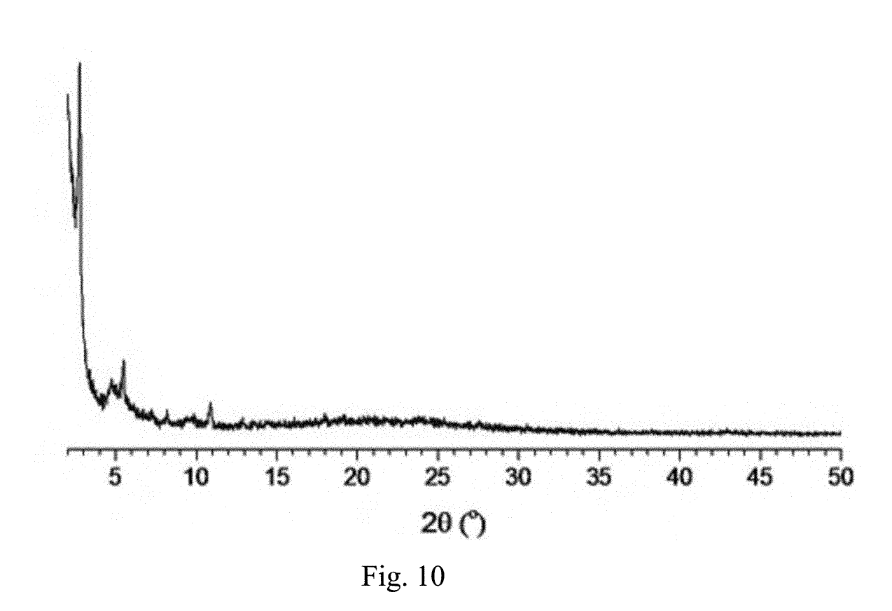

FIG. 10 is a diagram showing a PXRD result of the Example 8. As shown in FIG. 10, the structure of the modified porous organic framework AlTz68-methyl amide is the same as that of the porous organic framework AlTz68. In other words, in Example 8, the modifying groups are successfully modified to the porous organic framework AlTz68, and the structure of the porous organic framework AlTz68 is not changed.

Example 9: modified porous organic framework AlTz68-acetone. The manufacturing method is as follows. The porous organic framework AlTz53 (manufacturing method thereof shown in Example 1) with an amount of 10 mg is immersed in 3.0 ml ether for a solvent replacement, which is repeated three times. Then the porous organic framework AlTz53 is immersed in ether, a height of the ether is 0.5 cm higher than that of the porous organic framework AlTz53. The mixture of the porous organic framework AlTz53 and ether is put in an oven and is heated at 75° C. for 1 hour, so that the porous organic framework AlTz68 is obtained.

The porous organic framework AlTz68 is washed with 3.0 ml ether for three times and then immersed in DMF with a volume about 3.0 ml, then 2.0 ml acetone is added therein to form a mixture. The mixture is heated at 70° C. for 12 hours so as to synthesize the modified porous organic framework AlTz68-acetone. The modified porous organic framework AlTz68-acetone is washed with ether and then immersed in ether. A height of the ether is 0.5 cm higher than that of the porous organic framework AlTz68-acetone. The mixture of the porous organic framework AlTz68-acetone and ether is put in an oven and is heated at 75° C. for 1 hour, so that the porous organic framework AlTz68-acetone is obtained. In Example 9, the porous organic framework AlTz53 is firstly conducted with a phase transformation step, then is conducted with a modifying step.

The reaction equation of the modifying step of Example 9 is shown in Table 9.

TABLE 9

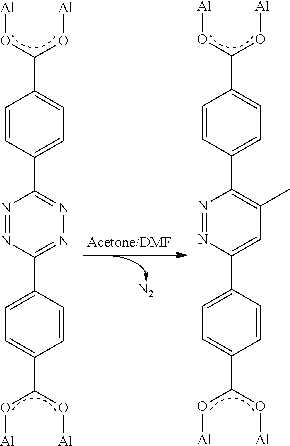

Because the porous organic framework AlTz68 reacts with the acetone via the tetrazine group, only one of the first ligands of the porous organic framework AlTz68 is shown. Furthermore, as shown in Table 9, after the reaction of the tetrazine group and the acetone, —CH₃ is modified to the porous organic framework AlTz68. In other word, the modifying group of Example 9 is —CH₃.

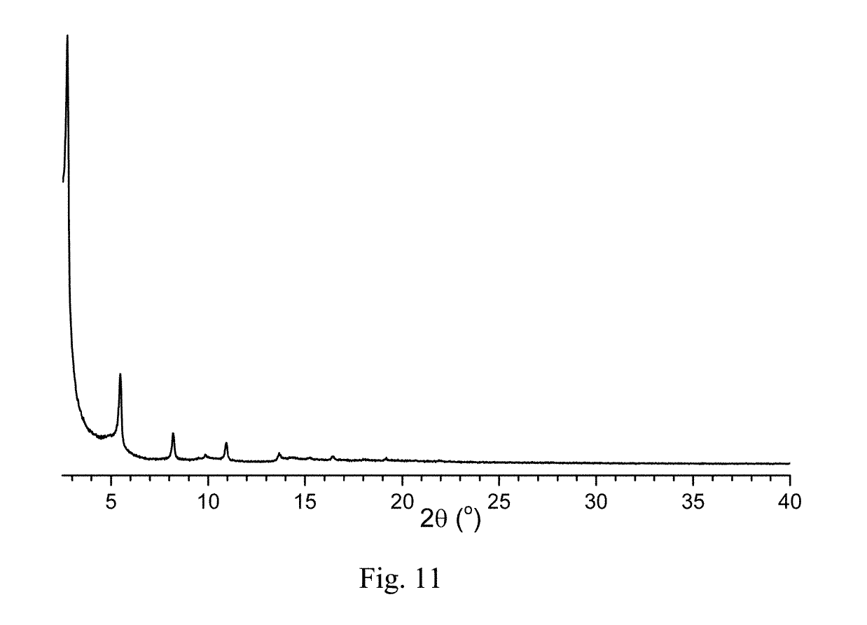

FIG. 11 is a diagram showing a PXRD result of the Example 9. As shown in FIG. 11, the structure of the modified porous organic framework AlTz68-acetone is the same as that of the porous organic framework AlTz68. In other words, in Example 9, the modifying groups are successfully modified to the porous organic framework AlTz68, and the structure of the porous organic framework AlTz68 is not changed.

Example 10: modified porous organic framework AlTz68-protoporphyrin IX-ZnCl₂. The manufacturing method is as follows. The porous organic framework AlTz53 (manufacturing method thereof shown in Example 1) with an amount of 10 mg is immersed in 3.0 ml ether for a solvent replacement, which is repeated three times. Then the porous organic framework AlTz53 is immersed in ether, a height of the ether is 0.5 cm higher than that of the porous organic framework AlTz53. The mixture of the porous organic framework AlTz53 and ether is put in an oven and is heated at 75° C. for 1 hour, so that the porous organic framework AlTz68 is obtained.

The porous organic framework AlTz68 is washed with 3.0 ml ether for three times and then immersed in methanol with a volume about 3.0 ml, then 0.5 ml protoporphyrin IX is added therein to form a mixture. The mixture is heated at 55° C. for 2 hours so as to synthesize the modified porous organic framework AlTz68-protoporphyrin IX-ZnCl₂. The modified porous organic framework AlTz68-protoporphyrin IX-ZnCl₂ is washed with ether and then immersed in ether. A height of the ether is 0.5 cm higher than that of the porous organic framework AlTz68-protoporphyrin IX-ZnCl₂. The mixture of the porous organic framework AlTz68-protoporphyrin IX-ZnCl₂ and ether is put in an oven and is heated at 75° C. for 1 hour, so that the porous organic framework AlTz68-protoporphyrin IX-ZnCl₂ is obtained. In Example 10, the porous organic framework AlTz53 is firstly conducted with a phase transformation step, then is conducted with a modifying step.

The reaction equation of the modifying step of Example 10 is shown in Table 10.

TABLE 10

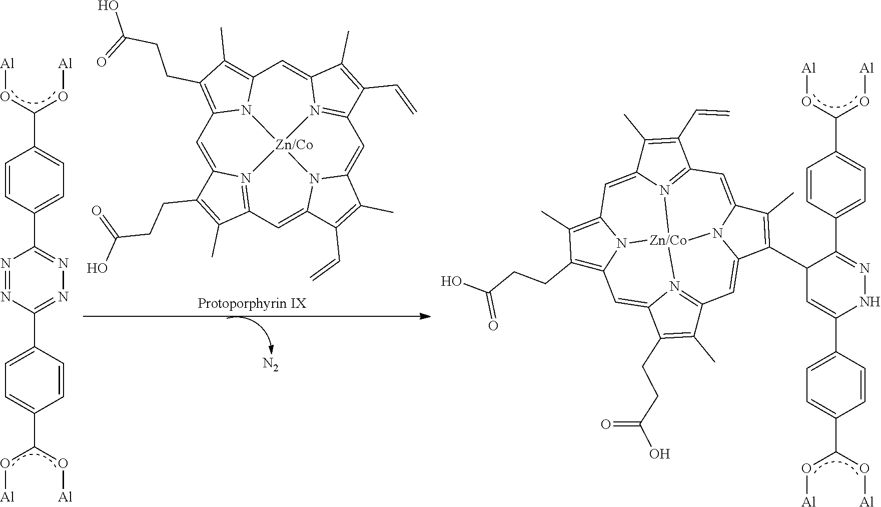

Because the porous organic framework AlTz68 reacts with the protoporphyrin IX via the tetrazine group, only one of the first ligands of the porous organic framework AlTz68 is shown. Furthermore, the modifying group is the residue group of the protoporphyrin IX after the reaction of the tetrazine group and the protoporphyrin IX.

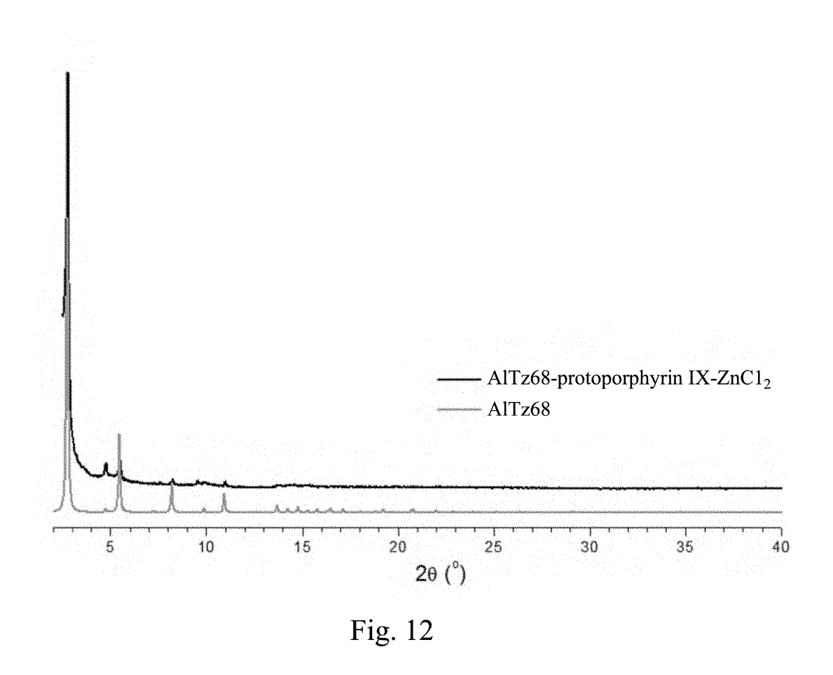

FIG. 12 is a diagram showing PXRD results of the porous organic framework AlTz68 and the modified porous organic framework AlTz68-protoporphyrin IX-ZnCl₂. As shown in FIG. 12, the structure of the modified porous organic framework AlTz68-protoporphyrin IX-ZnCl₂ is the same as that of the porous organic framework AlTz68. In other words, in Example 10, the modifying groups are successfully modified to the porous organic framework AlTz68, and the structure of the porous organic framework AlTz68 is not changed.

Example 11: modified porous organic framework lipase@AlTz68. The manufacturing method is as follows. The porous organic framework AlTz53 (manufacturing method thereof shown in Example 1) with an amount of 10 mg is immersed in 3.0 ml ether for a solvent replacement, which is repeated three times. Then the porous organic framework AlTz53 is immersed in ether, a height of the ether is 0.5 cm higher than that of the porous organic framework AlTz53. The mixture of the porous organic framework AlTz53 and the ether is put in an oven and is heated at 75° C. for 1 hour, so that the porous organic framework AlTz68 is obtained.

The porous organic framework AlTz68 is washed with 3.0 ml ether for three times and then immersed in hexane with a volume about 3.0 ml, then 250 μl phosphate buffered saline containing 50 mM lipase is added therein to form a mixture. The mixture is heated at 25° C. for 2 hours so as to synthesize the modified porous organic framework lipase@AlTz68. The modified porous organic framework lipase@AlTz68 is washed with ether for three times and then immersed in ether. A height of the ether is 0.5 cm higher than that of the porous organic framework lipase@AlTz68. The mixture of the porous organic framework lipase@AlTz68 and the ether is put in an oven and is heated at 75° C. for 1 hour, so that the porous organic framework lipase@AlTz68 is obtained. In Example 11, the porous organic framework AlTz53 is firstly conducted with a phase transformation step, then is conducted with a modifying step.

Because of the relationship between the length of the modifying group and the pore size of the porous organic framework AlTz68, the modifying group can be modified in the pores of the modified porous organic framework lipase@AlTz68.

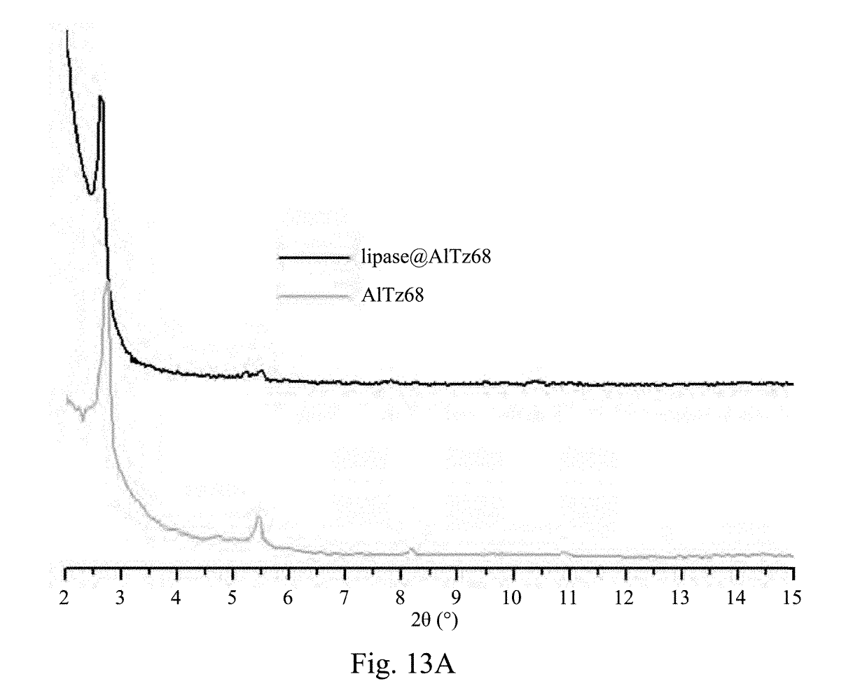

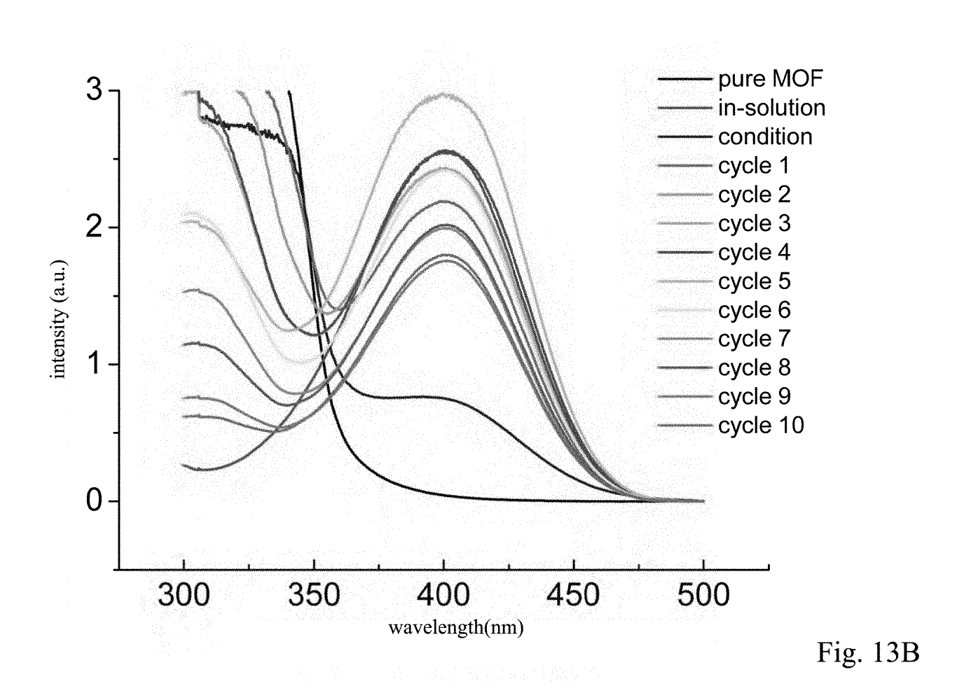

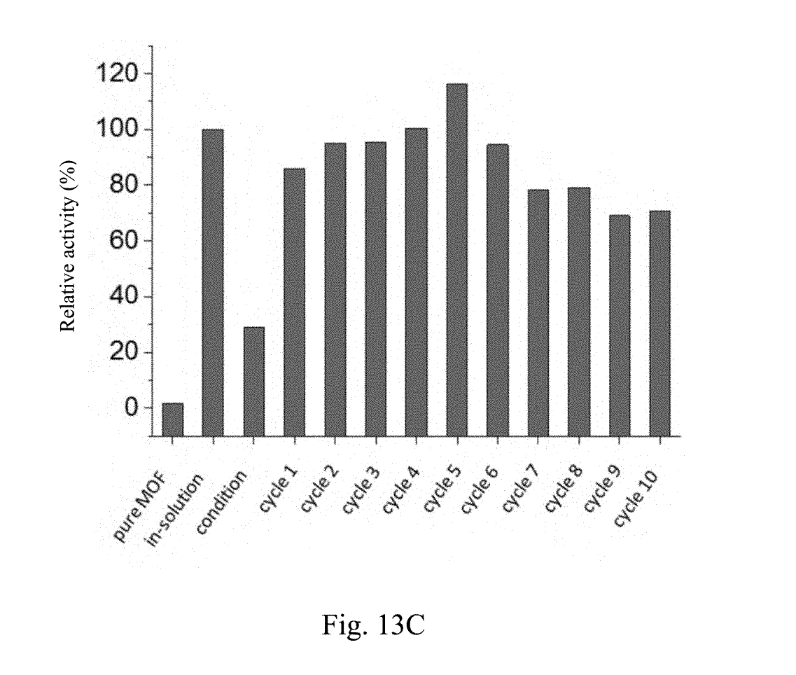

FIG. 13A is a diagram showing PXRD results of the porous organic framework AlTz68 and the modified porous organic framework lipase@AlTz68, wherein the PXRD result of the modified porous organic framework lipase@AlTz68 is measured after repeated use 10 times. As shown in FIG. 13A, the crystal structure of the lipase@AlTz68 is maintained after repeated use 10 times, which shows that the re-use of the lipase can be improved via modifying the lipase to the porous organic framework.

FIG. 13B shows absorption spectra of the porous organic framework AlTz68, a control example and Example 11. FIG. 13C shows relative activities of the porous organic framework AlTz68, the control example and Example 11. In FIG. 13B and FIG. 13C, in-solution is the control example. Specifically, FIG. 13B shows absorption intensities for ultraviolet light with a wavelength of 405 nm of the porous organic framework AlTz68, the control example and Example 11 after conducting a catalytic test. In FIG. 13C, the intensity is converted into relative activity and is shown in bars. Via FIG. 13B and FIG. 13C, the catalytic effect of the porous organic framework AlTz68, the control example and Example 11 can be observed, wherein pure MOF represents that the catalytic test use the porous organic framework AlTz68 as catalyst, in-solution represents that the catalytic test use the lipase as catalyst (i.e., homogeneous catalytic effect of single lipase), condition represents that the result of catalytic test of Example 11 after being used one time, cycle 1 represents that the result of catalytic test of Example 11 after repeated use 1 time (i.e., being used two times), cycle 2 represents that the result of catalytic test of Example 11 after repeated use 2 times (i.e., being used three times), the definition of cycle 3 to cycle 10 can be deduced in the same manner. Specifically, condition is measured after being used one time, i.e., Example 11 is used first time. In this case, the lipase dose not completely adapt to the solvent, and the activity thereof is not fully shown yet. Accordingly, the relative activity thereof is lower, which can be regarded as a heterogeneous catalytic effect. As for cycle 1 to cycle 10, the lipase adapts to the solvent gradually, so that the activity thereof is shown. Accordingly, the relative activity of each of cycle 1 to cycle 10 is higher than that of condition. In FIG. 13C, the intensity of in-solution is defined as the relative activity thereof equaling to 100%. The calculation method of the relative activity of each of cycle 1 to cycle 10 is as follows. Use the intensity of in-solution in FIG. 13B as denominator, and use the intensity of each of cycle 1 to cycle 10 in FIG. 13B as numerator to obtain a fraction, then the fraction is multiplied by 100%, the general formula can be represented as follows: [(intensity of cycle #/intensity of in-solution)×100%, #=1-10. The calculation method of each of the relative activity of pure MOF and condition is similar to that of cycle 1 to cycle 10. As shown in FIG. 13B and FIG. 13C, it is favorable for the re-use of the lipase by modifying the lipase to the porous organic framework.

Example 12: porous organic framework composite AlTz53-glass. The manufacturing method is as follows. For etching a glass substrate, 50 wt % HF_{(aq)} with an amount of 1 ml is dispersed on a surface of the glass substrate, then the glass substrate is washed with 3.0 ml deionized water for three times. After drying in oven, the glass substrate is immersed in strong acidic solution under 50° C. for 3 hours so as to modify hydroxyl groups on the surface of the glass substrate. The strong acidic solution is a mixture of H₂SO₄ and H₂O₂ in a volume ratio of 3:1. The glass substrate is washed with 3.0 ml deionized water for five times, then is dried in an oven. A toluene-based solution is obtained by mixing 1 ml vinyltrimethoxysilane and 5 ml toluene. The glass substrate modified with the hydroxyl groups is immersed in the toluene-based solution at 70° C. for 12 hours so as to modify alkenyl groups on the surface of the glass substrate. A H₂TZDB containing solution is prepared by dissolving 3 ml H₂TZDB with 5 ml DEF. The glass substrate modified with the alkenyl groups is immersed in the H₂TZDB containing solution at 120° C. for 30 minutes, then 13 mg AlCl₃ is added therein to react at 120° C. for 12 hours, so that the porous organic framework composite AlTz53-glass is obtained.

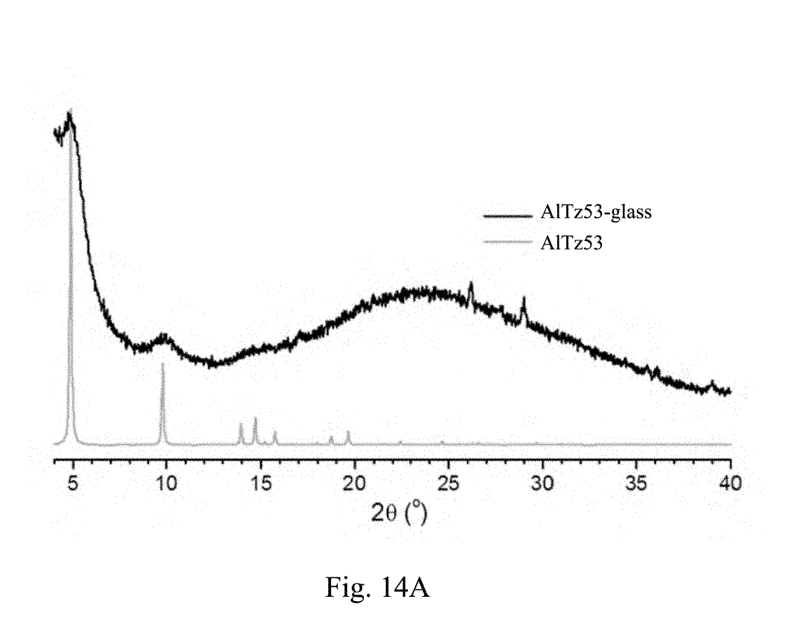

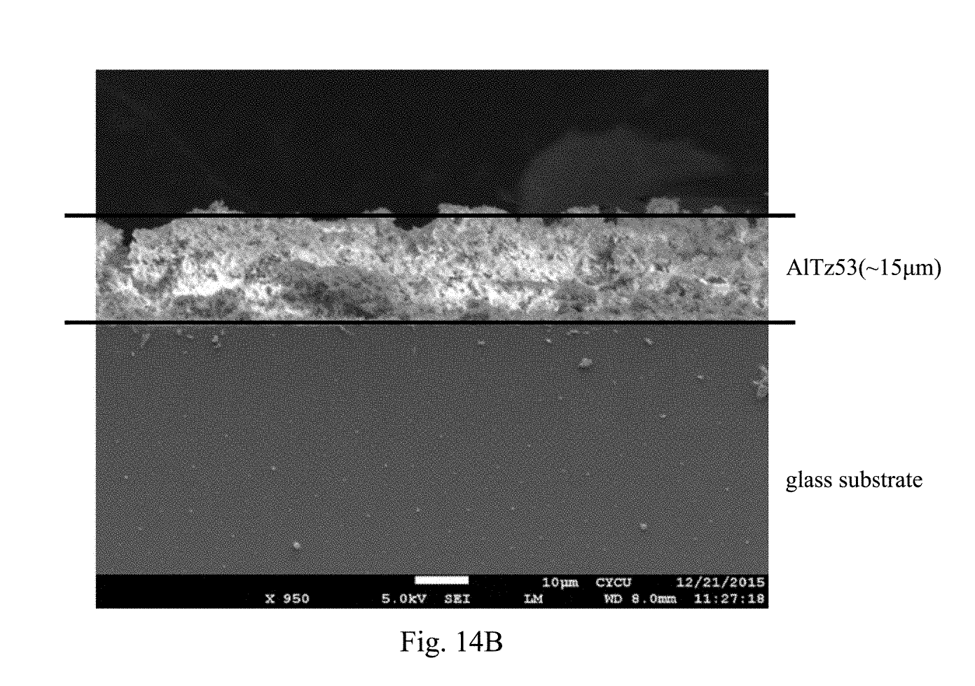

FIG. 14A is a diagram showing PXRD results of the porous organic framework AlTz53 and the porous organic framework composite AlTz53-glass. FIG. 14B is a SEM image of Example 12. As shown in FIG. 14A and FIG. 14B, Example 12 successfully combines the porous organic framework AlTz53 with the glass substrate so as to obtain the porous organic framework composite AlTz53-glass. Furthermore, the porous organic framework composite AlTz53-glass of Example 12 is a layered structure, and the porous organic framework AlTz53 is layered on the glass substrate. As shown in FIG. 14B, a thickness of the porous organic framework AlTz53 is about 15 μm.

Example 13: porous organic framework composite AlTz53-Si wafer. The manufacturing method of Example 13 is similar to that of Example 12. In Example 13, the glass substrate in Example 12 is replaced by a silicon (Si) wafer substrate, and other steps are the same as that of Example 12, so that details thereof in this regard will not be provided again.

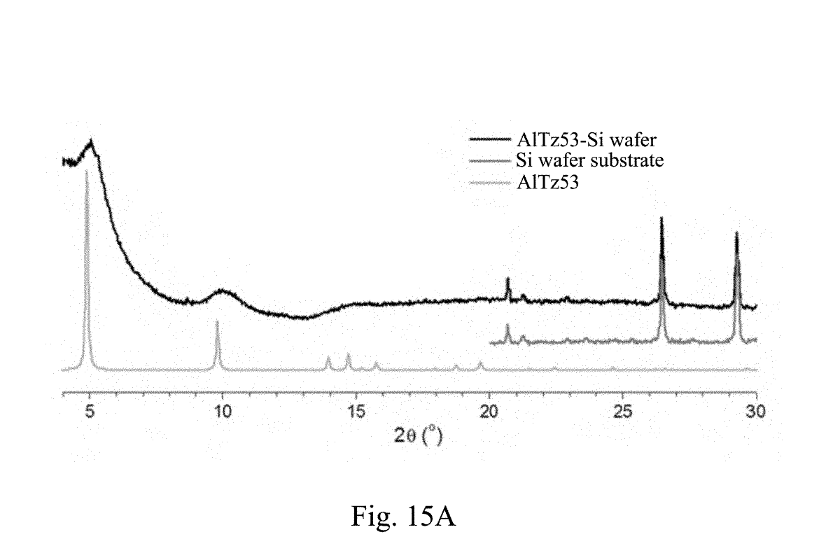

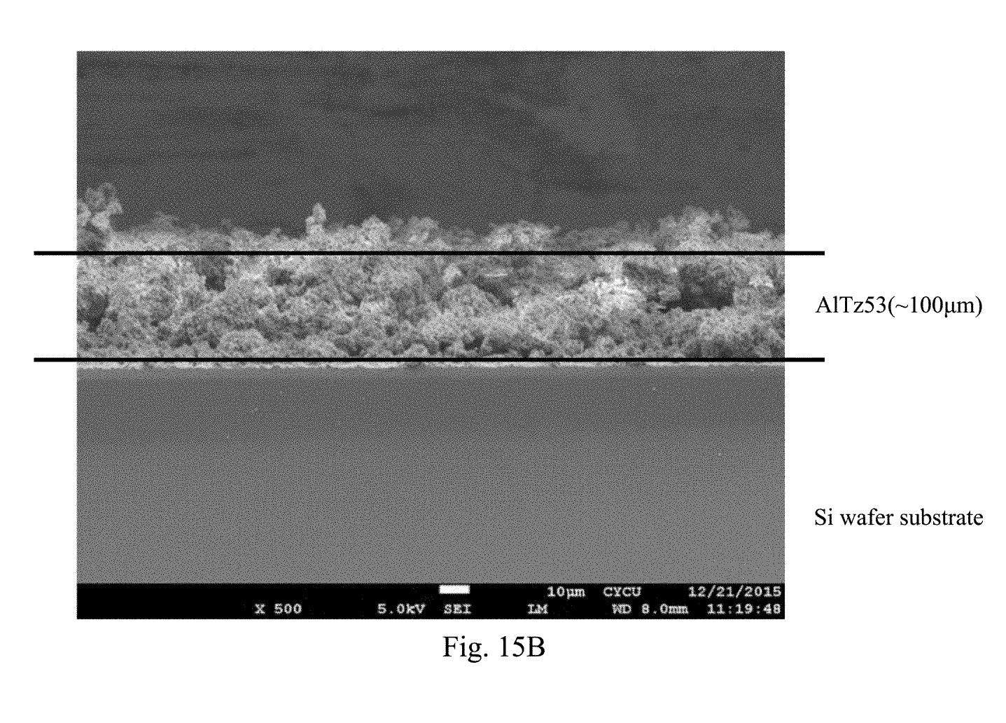

FIG. 15A is a diagram showing PXRD results of the porous organic framework AlTz53, the Si wafer substrate and the porous organic framework composite AlTz53-Si wafer. FIG. 15B is a SEM image of Example 13. As shown in FIG. 15A and FIG. 15B, Example 13 successfully combines the porous organic framework AlTz53 with the Si wafer substrate so as to obtain the porous organic framework composite AlTz53-Si wafer. Furthermore, the porous organic framework composite AlTz53-Si wafer of Example 13 is a layered structure, and the porous organic framework AlTz53 is layered on the Si wafer substrate. As shown in FIG. 15B, a thickness of the porous organic framework AlTz53 is about 100 μm.

Example 14: porous organic framework composite AlTz68-C₆₀. The manufacturing method is as follows. The porous organic framework AlTz53 (manufacturing method thereof shown in Example 1) with an amount of 10 mg is immersed in 3.0 ml ether for a solvent replacement, which is repeated three times. Then the porous organic framework AlTz53 is immersed in ether, a height of the ether is 0.5 cm higher than that of the porous organic framework AlTz53. The mixture of the porous organic framework AlTz53 and the ether is put in an oven and is heated at 75° C. for 1 hour, so that the porous organic framework AlTz68 is obtained.

The porous organic framework AlTz68 is washed with 3.0 ml ether for three times and then immersed in toluene with a volume about 3.0 ml, then 0.1 mg C₆₀ is added therein to form a mixture. The mixture is heated at 75° C. for 15 hours so as to synthesize the porous organic framework composite AlTz68-C₆₀. The porous organic framework composite AlTz68-C₆₀ is washed with toluene and then immersed in toluene. A height of the toluene is 0.5 cm higher than that of the porous organic framework composite AlTz68-C₆₀. The mixture of the porous organic framework composite AlTz68-C₆₀ and the toluene is put in an oven and is heated at 75° C. for 1 hour, so that the porous organic framework composite AlTz68-C₆₀ is obtained.

The reaction equation of the combining step of Example 14 is shown in Table 11.

TABLE 11

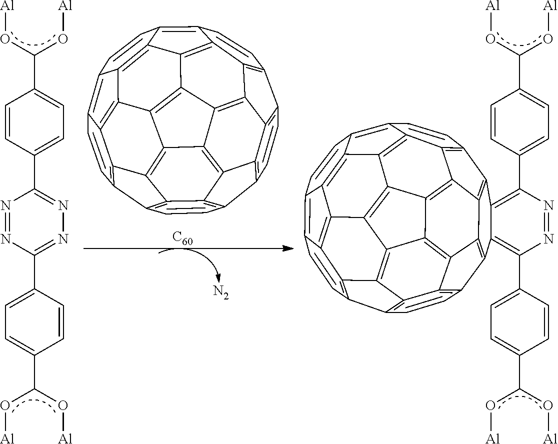

Because the porous organic framework AlTz68 reacts with the C₆₀ via the tetrazine group, only one of the first ligands of the porous organic framework AlTz68 is shown.

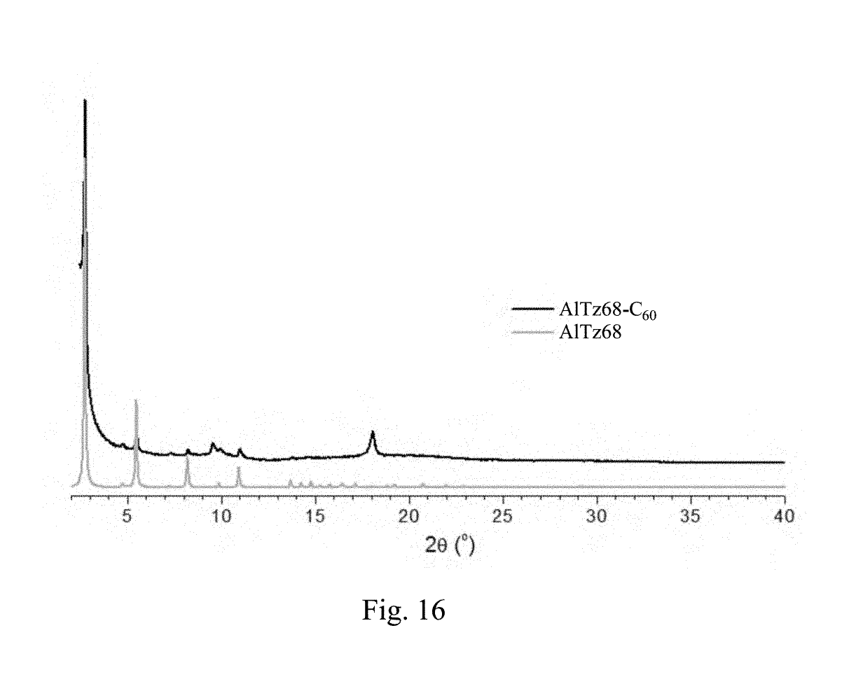

FIG. 16 is a diagram showing PXRD results of the porous organic framework AlTz68 and the porous organic framework composite AlTz68-C₆₀. As shown in FIG. 16, the structure of the porous organic framework composite AlTz68-C₆₀ is the same as that of the porous organic framework AlTz68. In other words, Example 14 successfully combines the C₆₀ with the porous organic framework AlTz68, and the structure of the porous organic framework AlTz68 is not changed. Furthermore, because of the relationship between the size of the C₆₀ and the pore size of the porous organic framework AlTz68, the C₆₀ can be disposed in the pores of the porous organic framework composite AlTz68-C₆₀.

Example 15: porous organic framework composite AlTz68-MWCNT. The manufacturing method is as follows. The porous organic framework AlTz53 (manufacturing method thereof shown in Example 1) with an amount of 10 mg is immersed in 3.0 ml ether for a solvent replacement, which is repeated three times. Then the porous organic framework AlTz53 is immersed in ether, a height of the ether is 0.5 cm higher than that of the porous organic framework AlTz53. The mixture of the porous organic framework AlTz53 and the ether is put in an oven and is heated at 75° C. for 1 hour, so that the porous organic framework AlTz68 is obtained.

The porous organic framework AlTz68 is washed with 3.0 ml ether for three times and then immersed in toluene with a volume about 3.0 ml, then 0.1 mg multiwall carbon nanotubes (MWCNT) are added therein to form a mixture. The mixture is heated at 75° C. for 2 hours so as to synthesize the porous organic framework composite AlTz68-MWCNT. The porous organic framework composite AlTz68-MWCNT is washed with toluene and then immersed in toluene. A height of the toluene is 0.5 cm higher than that of the porous organic framework composite AlTz68-MWCNT. The mixture of the porous organic framework composite AlTz68-MWCNT and the toluene is put in an oven and is heated at 75° C. for 1 hour, so that the porous organic framework composite AlTz68-MWCNT is obtained.

The reaction equation of the combining step of Example 15 is shown in Table 12.

TABLE 12

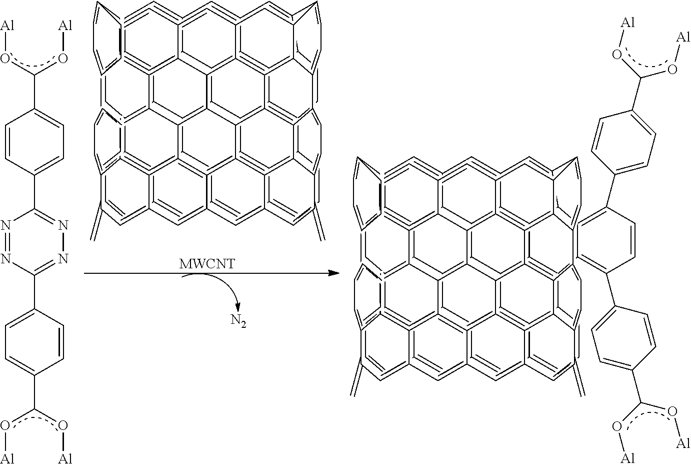

Because the porous organic framework AlTz68 reacts with the MWCNT via the tetrazine group, only one of the first ligands of the porous organic framework AlTz68 is shown.

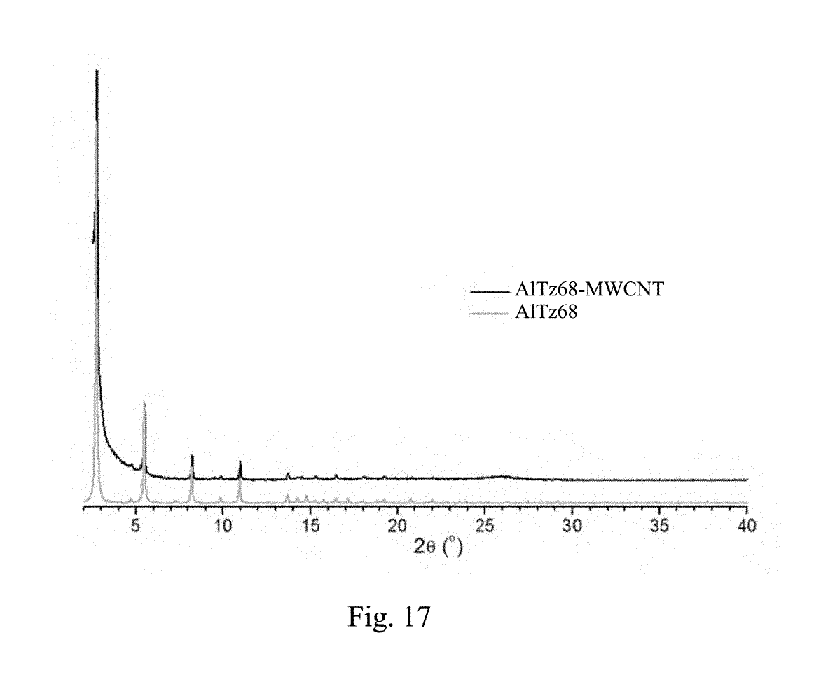

FIG. 17 is a diagram showing PXRD results of the porous organic framework AlTz68 and the porous organic framework composite AlTz68-MWCNT. As shown in FIG. 17, the structure of the porous organic framework composite AlTz68-MWCNT is the same as that of the porous organic framework AlTz68. In other words, Example 15 successfully combines the MWCNT with the porous organic framework AlTz68, and the structure of the porous organic framework AlTz68 is not changed.

Example 16: porous organic framework composite AlTz68-graphene. The manufacturing method is as follows. The porous organic framework AlTz53 (manufacturing method thereof shown in Example 1) with an amount of 10 mg is immersed in 3.0 ml ether for a solvent replacement, which is repeated three times. Then the porous organic framework AlTz53 is immersed in ether, a height of the ether is 0.5 cm higher than that of the porous organic framework AlTz53. The mixture of the porous organic framework AlTz53 and the ether is put in an oven and is heated at 75° C. for 1 hour, so that the porous organic framework AlTz68 is obtained.

The porous organic framework AlTz68 is washed with 3.0 ml ether for three times and then immersed in toluene with a volume about 3.0 ml, then 0.1 mg graphene is added therein to form a mixture. The mixture is heated at 75° C. for 15 hours so as to synthesize the porous organic framework composite AlTz68-graphene. The porous organic framework composite AlTz68-graphene is washed with toluene for three times and then immersed in toluene. A height of the toluene is 0.5 cm higher than that of the porous organic framework composite AlTz68-graphene. The mixture of the porous organic framework composite AlTz68-graphene and the toluene is put in an oven and is heated at 75° C. for 1 hour, so that the porous organic framework composite AlTz68-graphene is obtained.

The reaction equation of the combining step of Example 16 is shown in Table 13.

TABLE 13

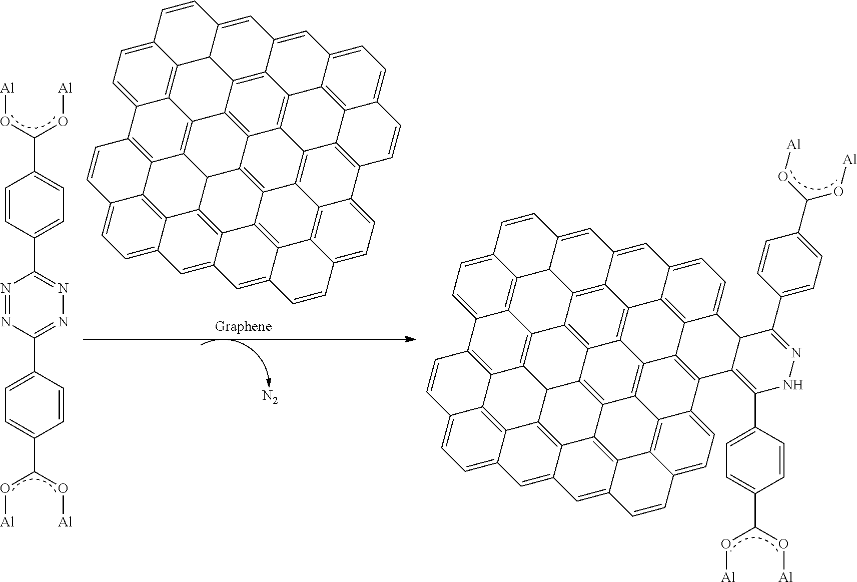

Because the porous organic framework AlTz68 reacts with the graphene via the tetrazine group, only one of the first ligands of the porous organic framework AlTz68 is shown.

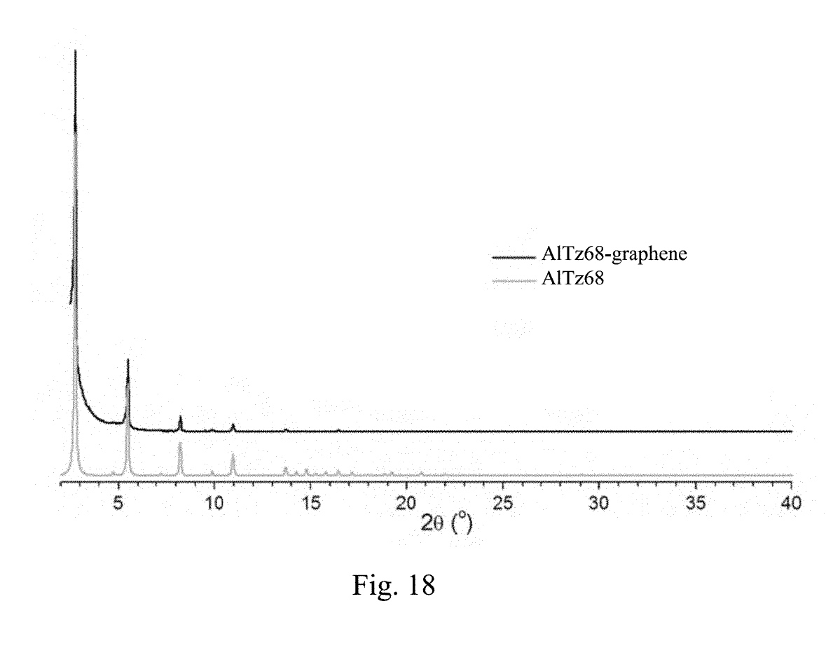

FIG. 18 is a diagram showing PXRD results of the porous organic framework AlTz68 and the porous organic framework composite AlTz68-graphene. As shown in FIG. 18, the structure of the porous organic framework composite AlTz68-graphene is the same as that of the porous organic framework AlTz68. In other words, Example 16 successfully combines the graphene with the porous organic framework AlTz68, and the structure of the porous organic framework AlTz68 is not changed.

Example 17: porous organic framework composite CQD. The manufacturing method is as follows. The first solution is formed by mixing 1 mg porous organic framework AlTz68 and 10 ml DMF. The second solution is formed by mixing 0.03 mg graphene and 10 ml toluene, wherein the size of the graphene is in the range of 2 nm to 10 nm. The first solution is mixed with the second solution and then is heated at 70° C. for 12 hours so as to form a solution of the porous organic framework composite CQD, wherein the porous organic framework composite CQD is dispersed in a mixed solvent of DMF and toluene.

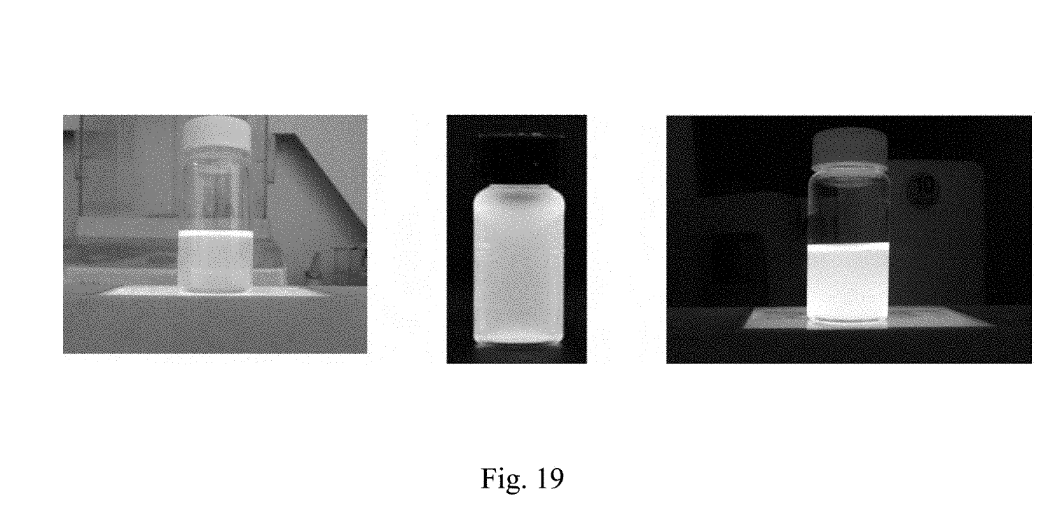

FIG. 19 shows results of the first solution, the second solution and the solution of the porous organic framework composite CQD irradiated with ultraviolet light, wherein a wavelength of the ultraviolet light is 365 nm. The left image of FIG. 19 shows the result of the first solution irradiated with ultraviolet light, which shows that the first solution emits blue purple light after being irradiated with ultraviolet light. The middle image of FIG. 19 shows the result of the second solution irradiated with ultraviolet light, which shows that the second solution emits yellow light after being irradiated with ultraviolet light. The right image of FIG. 19 shows the result of the solution of the porous organic framework composite CQD, which shows that the solution of the porous organic framework composite CQD emits near white light after being irradiated with ultraviolet light. In other words, when the size of carbon material is reduced, the porous organic framework composite can be prepared as CQD, which has the ability for tuning light color, and has the potential for the application of photoelectric field.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A method for manufacturing a modified porous organic framework, comprising:
providing a mixed solution, wherein the mixed solution comprises a porous organic framework, a plurality of group donors and a solvent, the porous organic framework comprises a plurality of first ligands, each of the first ligands comprises at least one tetrazine group, each of the group donors comprises a reactive group and a modifying group covalently connected with each other, and the reactive groups of the group donors are alkenyl groups, alkynyl groups, aldehyde groups, ketone groups or a combination thereof; and
conducting a modifying step, wherein at least one of the reactive groups of the group donors is reacted with at least one of the tetrazine groups of the first ligands, so that at least one of the modifying groups of the group donors is covalently connected with the porous organic framework, whereby the modified porous organic framework is obtained.

2. The method for manufacturing the modified porous organic framework of claim 1, wherein each of the group donors is a protoporphyrin IX.

3. The method for manufacturing the modified porous organic framework of claim 1, wherein each of the group donors is a lipase.

4. The method for manufacturing the modified porous organic framework of claim 1, wherein each of the group donors has a structure represented by Formula (IV-1), Formula (IV-2) or Formula (IV-3): 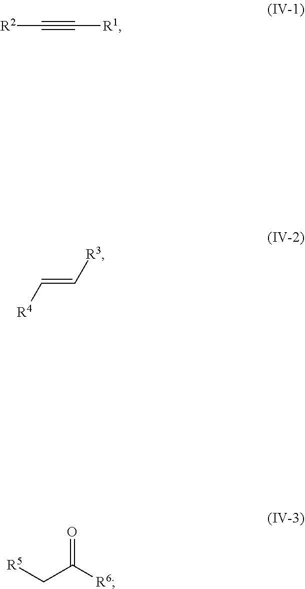
wherein each of R¹, R², R³, R⁴, Fe and R⁶ independently represents H or a C₁-C₄₀ monovalent organic group.

5. The method for manufacturing the modified porous organic framework of claim 4, wherein each of R¹, R², R³, R⁴, R⁵ and R⁶ independently represents H, a C₁-C₄₀ alkyl group or a C₆-C₄₀ phenyl group, at least one H of the C₁-C₄₀ alkyl group can be substituted by NH₂, F, Cl, Br or I, at least one CH₂ of the C₁-C₄₀ alkyl group can be substituted by NH or a carbonyl group, at least one H of the C₆-C₄₀ phenyl group can be substituted by NH₂, F, Cl, Br or I, at least one CH₂ of the C₆-C₄₀ phenyl group can be substituted by NH or a carbonyl group, and CH of a benzene ring of the C₆-C₄₀ phenyl group can be substituted by N.

6. The method for manufacturing the modified porous organic framework of claim 1, wherein the porous organic framework is formed by heating a mixture of 4,4′-(1,2,4,5-tetrazine-3,6-diyl)dibenzoic acid, aluminum chloride and N,N-diethylformamide, and each of the group donors is 1-octadecene.

7. The method for manufacturing the modified porous organic framework of claim 1, further comprising:
conducting a phase transformation step, wherein the modified porous organic framework is immersed in another solvent for a solvent replacement, then the modified porous organic framework is dried so as to obtain a modified porous organic framework with a different lattice structure.

8. A modified porous organic framework, wherein the modified porous organic framework is manufactured by the method for manufacturing the modified porous organic framework of claim 1.

9. A method for manufacturing a porous organic framework composite, comprising:
providing a first material, wherein the first material comprises a plurality of reactive groups, and the reactive groups are alkenyl groups, alkynyl groups, aldehyde groups, ketone groups or a combination thereof;
providing a porous organic framework source, wherein the porous organic framework source comprises a porous organic framework or a precursor of the porous organic framework, the porous organic framework and the precursor of the porous organic framework comprise a plurality of first ligands, and each of the first ligands comprises at least one tetrazine group; and
conducting a combining step, wherein at least one of the reactive groups of the first material is reacted with at least one of the tetrazine groups of the first ligands, so that the porous organic framework and the first material are covalently connected, whereby the porous organic framework composite is obtained.

10. The method for manufacturing the porous organic framework composite of claim 9, wherein the porous organic framework is a metal organic framework (MOF) or a covalent organic framework (COF).

11. The method for manufacturing the porous organic framework composite of claim 9, wherein the porous organic framework is a metal organic framework, and each of the first ligands has a structure represented by Formula (I-1), Formula (I-2), Formula (I-3), Formula (I-4) or Formula (I-5): 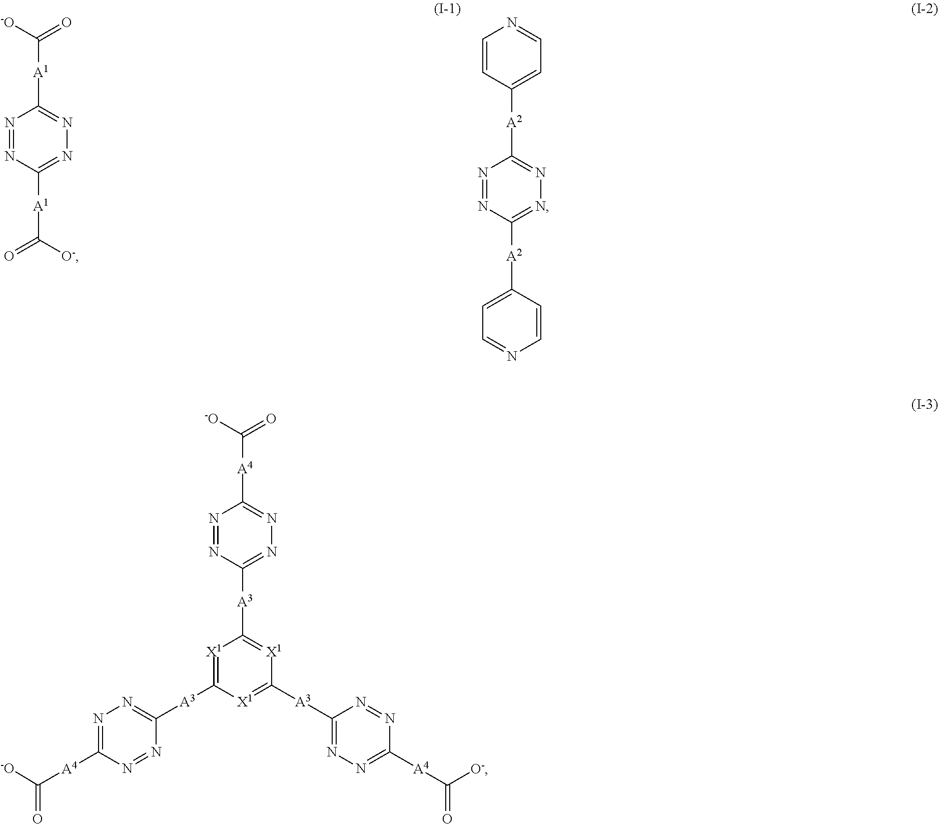 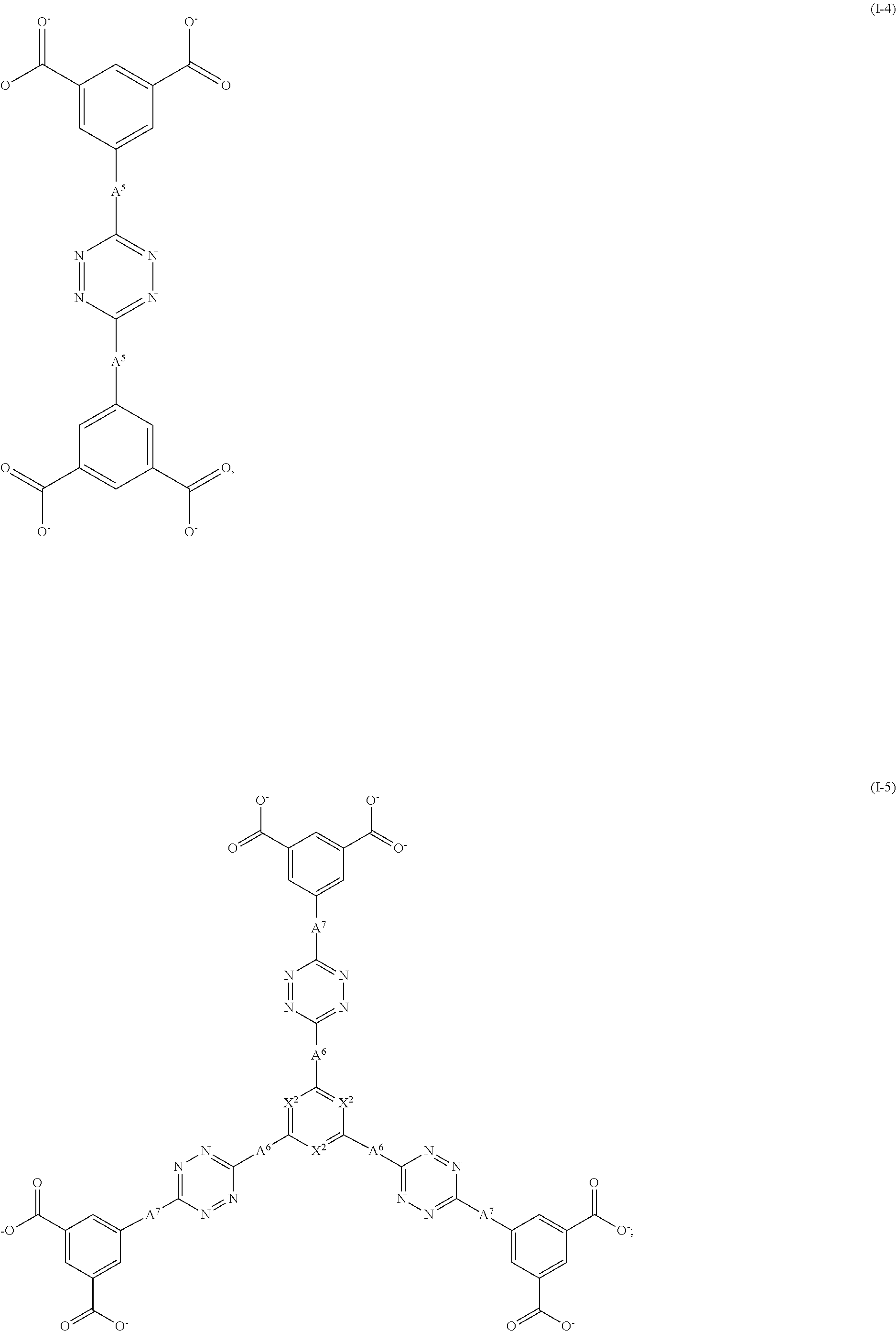
wherein each of A¹, A², A³, A⁴, A⁵, A⁶ and A⁷ independently represents a single bond or a divalent organic group, and each of X¹ and X² independently represents N or C.

12. The method for manufacturing the porous organic framework composite of claim 9, wherein the porous organic framework is a covalent organic framework, and each of the first ligands is provided by a compound having a structure represented by Formula (II-1), Formula (II-2) or Formula (II-3): 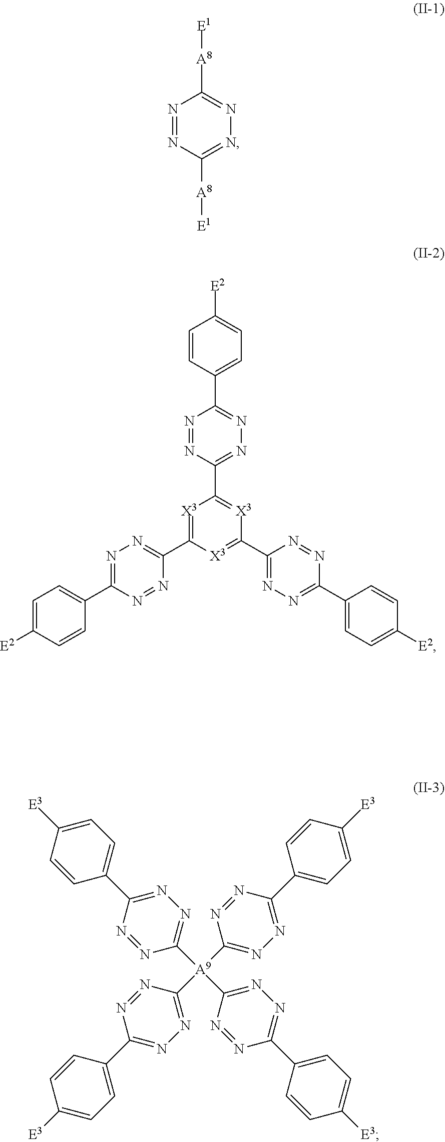
wherein each of A⁸ independently represents a single bond or a divalent organic group, A⁹ represents a tetravalent organic group, each of E¹, E² and E³ independently represents B(OH)₂, an amino group or an aldehyde group, and each of X³ independently represents N or C.

13. The method for manufacturing the porous organic framework composite of claim 12, wherein the porous organic framework further comprises a plurality of second ligands, one of the second ligands is covalently connected with one of the first ligands, and each of the second ligands is provided by a compound comprising a plurality of hydroxyl groups, a plurality of amino groups or a plurality of aldehyde groups.

14. The method for manufacturing the porous organic framework composite of claim 9, wherein the combining step is conducted at a temperature ranging from 100° C. to 130° C. for 12 hours to 24 hours.

15. The method for manufacturing the porous organic framework composite of claim 9, wherein the porous organic framework composite is a layered structure, the first material is a substrate, and the reactive groups are disposed on a surface of the substrate.

16. The method for manufacturing the porous organic framework composite of claim 15, wherein the substrate is a glass substrate or a silicon wafer substrate.

17. The method for manufacturing the porous organic framework composite of claim 9, wherein the first material is a carbon material, and the reactive groups are alkenyl groups.

18. The method for manufacturing the porous organic framework composite of claim 17, wherein the carbon material is C₆₀, a carbon tube or graphene.

19. A porous organic framework composite, wherein the porous organic framework composite is manufactured by the method for manufacturing the porous organic framework composite of claim 9.

20. The porous organic framework composite of claim 19, wherein the first material is a carbon material, the carbon material is C₆₀, a carbon tube or graphene, the reactive groups are alkenyl groups, and the porous organic framework composite is a carbon quantum dot.
